(19) United States
(12) Patent Application Publication
(10) Pub. No.: US 2005/0174664 A1
(43) Pub. Date: Aug. 11, 2005

(54) Dielectric multi layer thin film optical filter having predetermined wavelength optical characteristics, a method of manufacturing the same, a program for designing the same, and an optical add-drop system using the dielectric multi layer thin film optical filter

(75) Inventors: Takahiro Ito, Tokyo (JP); Kazuhiro Minagawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 10/969,956

(22) Filed: Oct. 22, 2004

(30) Foreign Application Priority Data
Feb. 3, 2004 (JP) 2004-027303

(51) Int. Cl. G02B 5/08; G02B 7/182

(52) U.S. Cl. 359/883

(57) ABSTRACT

A dielectric multi layer thin film type band-pass filter provided with the function of transmitting a predetermined wavelength band, the function of reflecting a predetermined wavelength band or both functions, where a film structure of the dielectric multi layer thin film optical filter is configured of, with respect to the center wavelength λ as a reference of the optical film thickness, (1) mirror layers each comprised of alternately layered layers (H) of high refractive index material and layers (L) of low refractive index material each with an optical film thickness of λ/4, and (2) spacer layers each of which is configured in a combination of a layer (nH: n is an integer) of high refractive index material and a layer (nL: n is an integer) of low refractive index material each with an optical film thickness of λ/4 and has a total optical film thickness of an integral multiple of λ/2.

### FIELD OF THE INVENTION

The present invention relates to a dielectric multi layer thin film optical filter, a method of manufacturing the same, a program for designing the same, and an optical add-drop system using the dielectric multi layer thin film optical filter.

### RELATED ART

With the advent of the broadband era, great expectations are placed on a WDM (Wavelength Division Multiplexing) communication system (hereinafter, abbreviated as “WDM”) that multiplexes a plurality of optical signals with different wavelengths to transmit.

One of key devices in the WDM communication system is a band-pass filter that selects a signal with a predetermined wavelength from the multiplexed optical signal and passes the selected signal through the filter.

Used as the band-pass filter is a dielectric multi layer thin film optical filter (hereinafter, also referred to as simply “multi layer thin film optical filter) having a film structure (multi-cavity structure) where a plurality of cavity layers (multi layer) are provided on an optical substrate.

In addition, “multi layer” in this specification is used as the meaning indicating a plurality of layers.

Namely, the multi layer thin film optical filter has a plurality of cavities layered through coupling layers. Each cavity has a spacer layer having an optical film thickness of a/2 (a is a natural number) times λ that is the center wavelength (center of two wavelengths that exhibit the transmittance of 50% in transmittance wavelength characteristics of each cavity), and a mirror layer which is formed on each of both sides of the spacer layer along the lamination direction, has an optical film thickness of b/4 (b is an odd number) times λ that is the center wavelength of a target transmittance wavelength band, and comprises two thin layers of two kinds of different refractive indexes (a high refractive index layer with a high refractive index; H layer and a low refractive index layer with a low refractive index; L layer) that are alternately arranged to be symmetric with respect to the spacer layer (see JP 2002-196129).

In recent years with optical signal transmission such as WDM sophisticated, optical characteristics required for multi layer thin film optical filters as described above such as a band-pass filter, band separator, C/L filter, B/R filter, SWPF and LWPF have been advanced (wide band and steep isolation). In order to implement such advanced optical characteristics, it is necessary to further increase the number of cavities for multi layer.

However, in the multi-cavity structure, i.e. a structure where cavities with the same structure are repeatedly laminated, it is known that as the number of cavities increases, a ripple increases that is generated in a target transmittance wavelength band (target band).

Since the ripple has a risk of having an adverse effect on transmittance wavelength characteristic of a multi layer thin film optical filter, the multi layer thin film optical filter requires a film structure that enables maximized suppression of the ripple.

Conventionally, there is commercially available optical film structure designing software (program) having the function for optimizing a film thickness or the like of each film layer. Such software is only effective in the case where an object targeted for optimization (in this case, film thickness) is continuous {AR (Anti-Reflection) layer, GFF (Gain Flattening Filter) film layer, Edge Filter film layer, etc.}.

However, as described above, in the case of a multi layer thin film optical filter such as a band-pass filter that allows an optical film thickness of only an integer times one-quarter of center wavelength λ (λ/4) of a target band, it is difficult to apply existing optimization algorithm, and it is thus difficult to design a film thickness of the multi layer thin film optical filter as described above using the commercially available optical film structure designing software.

Further, in recent years with the optical signal transmission such as WDM sophisticated, optical characteristics required for optical thin films have been advanced. In order to use a band without waste, a filter is demanded that has a wide transmittance band and a steep band separation characteristic. Furthermore, in order to construct an optical network more optionally, a filter is demanded that collectively separates a plurality of bands (or wavelengths).

### SUMMARY OF THE INVENTION

It is an object of the present invention to provide a dielectric multi layer thin film optical filter having predetermined optical characteristics in a target band, a method of manufacturing such a filter, a program for designing such a filter, and an optical add-drop system using the dielectric multi layer thin film optical filter.

A multi layer thin film optical filter comprises:
an optical substrate having a prescribed refractive index in a predetermined wavelength band of which center wavelength is λo;
a coupling layer having an optical film thickness of m1λo/4 (m1 being a positive odd number);
a cavity including a spacer layer having an optical film thickness of m2λo/4 (m2 being a natural number), and a mirror layer having an optical film thickness of m3λo/4 (m3 being a positive odd number) comprising two thin layers of two kinds of different refractive indexes in which said mirror layers are symmetrically arranged to said spacer layer in such manner that said two thin layers are alternately arranged; and
an anti-reflection layer having a prescribed optical film thickness,
wherein, a plurality of said cavities are layered through said coupling layers between said optical substrate and said anti-reflection layer, and each of said cavities is represented by a center wavelength and a full width of half maximum (FWHM), and is designed by an optimization process.

### BRIEF DESCRIPTION OF THE DRAWINGS

FIG. 1 is a view showing a multi layer thin film optical filter according to a first embodiment of the present invention;

FIG. 2 is a diagram illustrating a hardware configuration of a filter designing apparatus for designing the multi layer thin film optical filter as shown in FIG. 1;

FIG. 3 is a graph showing transmittance-wavelength characteristics (X-Y characteristics) of one cavity;

FIG. 4 is a schematic flowchart showing an example of filter designing processing of a computer of the filter designing apparatus as illustrated in FIG. 2;

FIG. 5 is a graph showing wavelength dependence of transmittance and equivalent admittance of a multi layer thin film optical filter designed using a film structure designing scheme described in the first embodiment;

FIG. 6 is a graph showing wavelength dependence of transmittance and equivalent admittance of a multi layer thin film optical filter;

FIG. 7 is a diagram illustrating a hardware configuration of a filter designing apparatus for designing the multi layer thin film optical filter (see FIG. 1) according to a second embodiment of the present invention;

FIG. 8 is a schematic flowchart showing an example of filter designing processing of a computer of the filter designing apparatus as illustrated in FIG. 7;

FIG. 9 is a graph showing wavelength dependence in a nine-cavity multi layer thin film optical filter designed using a conventional film structure designing scheme;

FIG. 10 is a graph showing wavelength dependence in a nine-cavity multi layer thin film optical filter designed using a film structure designing scheme of the second embodiment;

FIG. 11 is a table illustrating comparison between a film structure of a first cavity of the multi layer thin film optical filter using the conventional film structure designing scheme as illustrated in FIG. 9 and a film structure of a first cavity of the multi layer thin film optical filter using the film structure designing scheme of this embodiment as illustrated in FIG. 10;

FIG. 12 is a table illustrating comparison between a film structure of a second cavity of the multi layer thin film optical filter using the conventional film structure designing scheme as illustrated in FIG. 9 and a film structure of a second cavity of the multi layer thin film optical filter using the film structure designing scheme of this embodiment as illustrated in FIG. 10;

FIG. 13(a) and FIG. 13(b) are graphs each showing a waveform in an ideal solution and a waveform in an actual solution of transmittance in a predetermined wavelength band;

FIG. 14 is a configuration diagram showing an example of an optical add-drop system;

FIG. 15 is a configuration diagram showing another example of the optical add-drop system;

FIG. 16 is a configuration diagram showing still another example of the optical add-drop system;

FIG. 17 is a graph showing GDR with respect to wavelengths of a 4skip0 filter and 100 GHz-BPF;

FIG. 18 is a graph showing GDR of an isolation moderation type 100 GHz-BPF used in dropping signal light of channels Sa and Sd after dropping signal light of channels Sb and Sc;

FIG. 19(A) is a graph showing transmittance characteristics of the isolation moderation type and general type 100 GHz-BPFs;

FIG. 19(B) is a graph showing GDR of the isolation moderation type and general type 100 GHz-BPFs;

FIG. 20 is a configuration diagram showing an example using an edge filter in an optical add-drop system;

FIG. 21 is a graph showing transmittance characteristics of the edge filter used in FIG. 20 and 100 GHz-BPF;

FIG. 22 is a graph showing accumulation GDR in reflected light Rc and GDR of edge filter 110e;

FIG. 23 is a view showing a basic structure of a band-pass filter;

FIG. 24 is a view showing an example of transmittance waveform of a band-pass filter;

FIG. 25 illustrates an example of conventional design of a 4skip0-100 GHz filter;

FIG. 26 illustrates a 4skip0-100 GHz filter with a spacer layer of a multi-layer structure whereby the ripple in a transmittance band is reduced;

FIG. 27 illustrates design with two transmittance bands where a spacer layer has a multi-cavity structure comprised of two cavities;

FIG. 28A and FIG. 28B illustrate a 4skip0-100 GHz filter of conventional design;

FIG. 29A and FIG. 29B illustrate a 4skip0-100 GHz filter with a spacer layer of a multi-layer structure whereby the ripple in a transmittance band is reduced;

FIG. 30 illustrates design with a spacer layer of a multi-layer structure whereby the ripple in a transmittance band is reduced in vertical incidence;

FIG. 31 illustrates design with a spacer layer of a multi-layer structure whereby the ripple in a transmittance band is reduced in vertical incidence and further with each cavity adjusted to have a wavelength shift of similar extent in oblique incidence;

FIG. 32 shows a waveform of a band-pass filter of design such that the spacer layer has a multi-cavity structure comprised of two cavities;

FIG. 33 shows an ideal solution of a band-pass filter satisfying characteristics such that a transmittance bandwidth is 30 nm or more and a cutoff width is 45 nm or less;

FIG. 34 shows a waveform of optimal design;

FIG. 35 shows another waveform of optimal design;

FIG. 36 is a view illustrating a method of using a band-pass filter;

FIG. 37 shows a design waveform of a band-pass filter;

FIG. 38 shows oblique incident characteristics when light is passed through the filter inclined at angles of 0° to 3°;

FIG. 39 shows oblique incident characteristics of design where a fourth cavity and a sixth cavity are changed;

FIG. 40 is a graph to explain a 0.5 dB width;

FIG. 41 shows a general cavity structure and its transmittance characteristics;

FIG. 42 shows a structure and transmittance waveform in the case where a spacer layer has a multi-cavity structure comprised of two cavities;

FIG. 43 shows a structure and transmittance waveform in the case where a spacer layer has a multi-cavity structure comprised of three cavities;

FIG. 44 shows an example of a multi-cavity structure having four laminated first cavities in each of which a second multi-cavity is comprised of two second cavities; and

FIG. 45 shows transmittance waveforms and a structure of a triple cavity structure where a spacer layer constituting a second cavity has a multi-cavity structure.

### DETAILED DESCRIPTION OF THE INVENTION

As described above, dielectric multi layer thin film optical filters are used in various applications due to their excellent characteristics.

For example, using the multi-cavity structure as described above, it is possible to design and manufacture a narrow band-pass filter (NBPF) that separates and/or adds a wavelength band corresponding to a single signal, band separator that collectively separates and/or adds wavelengths corresponding to a number of signals of WDM, C/L filter that divides a wide wavelength band into two bands, B/R filter, etc.

In addition to the aforementioned filters, a filter having the multi-cavity structure is used as a so-called edge filter such as SWPF (Short Wavelength Pass Filter) that passes light of a band of wavelengths shorter than a specific wavelength while cutting off light except the light of such a band, LWPF (Long Wavelength Pass Filter) that passes light of a band of wavelengths longer than a specific wavelength while cutting off light except the light of such a band.

Specific embodiments will be described below with reference to accompanying drawings.

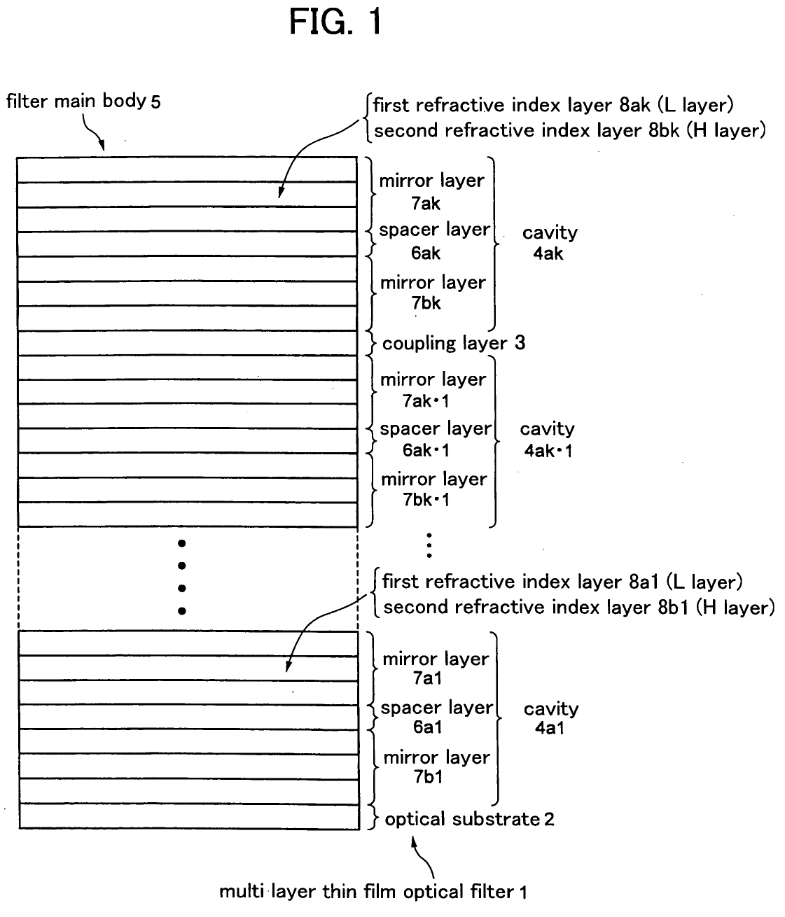

FIG. 1 is a view showing a multi layer thin film optical filter 1 according to an embodiment of the present invention. This embodiment describes as the multi layer thin film optical filter 1 a multi layer thin film optical filter to obtain predetermined optical characteristic values (transmittance and target characteristic values) in a predetermined transmittance wavelength band (target band; transmittance wavelength band and cutoff wavelength band) of which the center wavelength is λ0.

As shown in FIG. 1, the multi layer thin film optical filter 1 is provided with a filter main body 5 having an optical substrate 2, coupling layers 3 each having an optical film thickness of m₁/4 (m₁ is a positive odd number) times the center wavelength λ0, and a plurality of cavities 4a1 to 4ak (k is an integer of two or more) layered via respective coupling layers 3. In addition, a first cavity (4a1) is a cavity of the lowest layer directly laminated on the optical substrate 2, the cavity number increases in the order in which the cavity is away from the optical substrate 2 (towards the medium side), and a kth cavity (4ak) is a cavity of the farthest layer (uppermost layer) from the optical substrate 2 along the lamination direction.

Coupling layers 3 and the plurality of cavities, 4a1 to 4ak, are formed to be films and laminated on the substrate 2, for example, by deposition, sputtering or the like.

As shown in FIG. 1, the cavities 4a1 to 4ak respectively have spacer layers 6a1 to 6ak each having an optical film thickness of m₂/2 (m₂ is a natural number) times the center wavelength λ0.

The first cavity 4a1 is provided with mirror layers 7a1 and 7b1 formed on both sides of a spacer layer 6a1 along the lamination direction.

Each of the mirror layers 7a1 and 7b1 has an optical film thickness of m₃/4 (m₃ is a natural number) times the center wavelength λ0 in which a plurality of first refractive index layers 8a1 and second refractive index layers 8b1 with different diffractive indexes are alternately arranged to be symmetric with respect to the spacer layer along the lamination direction.

The refractive index n_{L} of each first refractive index layer 8a1 is smaller than the refractive index nH of each second refractive index layer 8b1. Hereinafter, the first refractive index layer 8a1 is referred to as an L layer, while the second refractive index layer 8b1 is referred to as an H layer.

Examples of material for forming a film of the H layer include tantalum pentoxide (Ta₂O₅), and examples of material for forming a film of the L layer include silica (SiO₂).

Similarly, second to kth cavities 4a2 to 4ak are provided with mirror layers 7a2 to 7ak and mirror layers 7b2 to 7bk formed on both sides of spacer layers 6a2 to 6ak along the lamination direction, respectively. Each of the mirror layers 7a2 to 7ak and 7b2 to 7bk has L layers 8ak and H layers 8bk each of which has an optical film thickness of (m₃/4 (m₃ is a positive odd number) times the center wavelength λ0 and which are alternately arranged to be symmetric with respect to the spacer layer along the lamination direction.

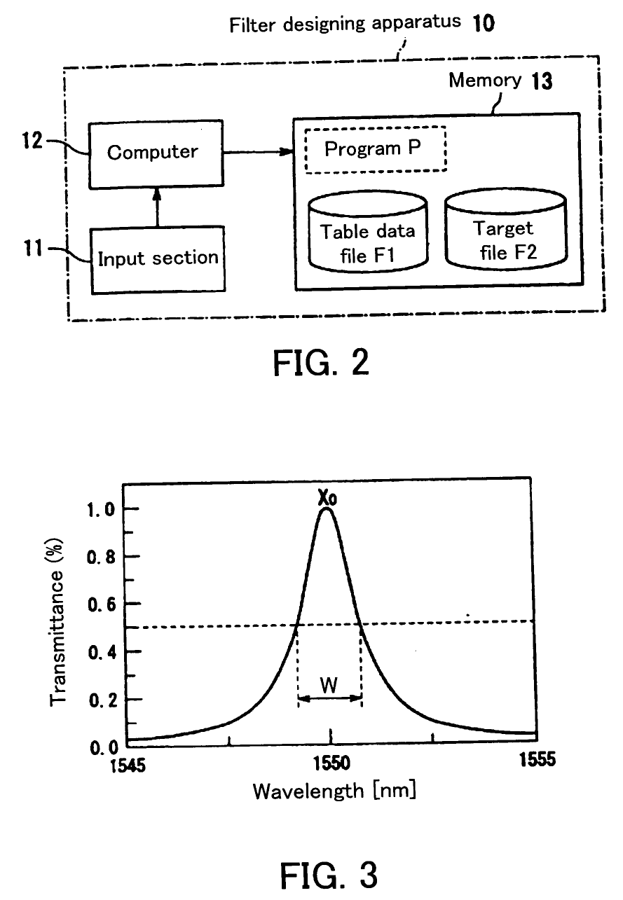

FIG. 2 is a diagram illustrating a hardware configuration of a filter designing apparatus 10 for designing a film structure of the multi layer thin film optical filter 1 as shown in FIG. 1.

As illustrated in FIG. 2, the filter designing apparatus 10 is a computer system and provided with an input section 11 for a designer to operate and input information, a computer 12 connected to the input section 11, and a memory 13 as a storage medium which is connected to the computer 12 and beforehand stores a program P to execute filter designing processing as described later. In addition, as the storage medium, various storage media are applicable such as a semiconductor memory and magnetic memory.

Specific descriptions are given below of the algorithm of the program P stored in the memory 13, i.e. the filter manufacturing method of this embodiment.

It is known that transmittance-wavelength characteristics of a cavity exhibit a similar shape irrespective of the number of alternate laminations (the number of mirror pairs) of the cavity and the total layer thickness of the cavity.

Specifically, the transmittance-wavelength characteristics (x-y characteristics) of a cavity as shown in FIG. 3 are represented by the Lorentz function indicated by following equation (1):

$$y = {y}_{0} + \frac{2 A}{π} * \frac{W}{4 * {( x - {x}_{0} )}^{2} + {W}^{2}} \qquad ( 1 )$$

where y, x, y₀, A, x₀, and w respectively represent transmittance (T), wavelength (nm), offset of baseline, total area between the curve and baseline, center of the peak of the curve, and full width of half maximum (full width of half maximum of the curve).

The full width of half maximum in the transmittance wavelength characteristics of a cavity indicates a width of two wavelengths exhibiting transmittance of 50% in the transmittance wavelength characteristic.

At this point, in transmittance calculation, since offset y₀ is 0, the transmittance y-x characteristics are expressed by only the center wavelength x₀ and full width of half maximum W as indicated by following equation (2):

$$y = \frac{{W}^{2}}{4 * {( x - {x}_{0} )}^{2} + {W}^{2}} \qquad ( 2 )$$

For example, a band-pass filter comprised of a multi layer thin film optical filter {AR layers (LH two layers; \mathring{1} and \mathring{2}) to medium (air), five cavities (cavities \mathring{1} to \mathring{5}) with the center wavelength λ0} is represented by two schemes as shown in Table 1 described below.

TABLE 1

| | Abbreviation | | Scheme of this |
|---|---|---|---|
| cavity | scheme | | embodiment |
| AR layer \mathring{1} | 0.33λ0 | | 0.33λ0 |
| AR layer \mathring{2} | 0.08λ0 | | 0.08λ0 |
| Cavity \mathring{1} | 686 | =(HL)⁶H8LH(LH)⁶ | λ0, W1 |
| Cavity \mathring{2} | 787 | =(HL)⁷H8LH(LH)⁷ | λ0, W2 |
| Cavity \mathring{3} | 7107 | =(HL)⁷H10LH(LH)⁷ | λ0, W3 |
| Cavity \mathring{4} | 787 | =(HL)⁷H8LH(LH)⁷ | λ0, W4 |
| Cavity \mathring{5} | 686 | =(HL)⁶H8LH(LH)⁶ | λ0, W5 |
| Optical | | | |
| substrate | | | |

Namely, the five-cavity filter as illustrated in Table 1 is represented by following expression (3):
AR layer (\mathring{1} AR layer \mathring{2} Cavity \mathring{1} Cavity \mathring{2} Cavity \mathring{2} Cavity \mathring{4} Cavity \mathring{5} Optical substrate (3)

Each cavity in the multi layer thin film optical filter as represented by above expression (3) can be abbreviated as indicated by following expression (4) by the abbreviation scheme for omitting a film structure itself to abbreviate, using the number of LH alternately laminated layers (the number of mirror pairs) and spacer layer thickness as indicators.
yxy (4)

The yxy indicates cavity (HL)^{y}HxLH(LH)^{y} having mirror layers each with y mirror pairs each comprised of an H layer (indicated by H) and L layer (indicated by L) each having an optical film thickness of ¼ times the center wavelength, and a spacer layer with the spacer layer thickness of xL. Accordingly, 686 represents a cavity structure of (HL)⁶H8LH(LH)⁶.

Meanwhile, as described above, the cavity is represented by its center wavelength and full width of half maximum. Therefore, for example, Cavity \mathring{1} to Cavity \mathring{5} corresponding to the same center wavelength λ 0 are represented by using the center wavelength λ 0 and different full width of half maximums W1 to W5, respectively.

At this point, with respect to full width of half maximums W1 to W5, limitations imposed on film thicknesses (only film thicknesses of an integer times ¼ of the center wavelength λ0 (λ0/4)) are not present. Therefore, by optimizing each of full width of half maximums W1 to W5, for example, by using an optimization algorithm based on an optimization process (Levenberg-Marquardt process, Simplex process, Gauss-Newton process, etc.) using target characteristic values of the entire cavity (entire filter) as references, it is possible to design the multi layer thin film optical filter 1 having approximate target characteristic values.

Further, in this embodiment, for each cavity film structure (the number of cavities, the number of alternately laminated L and H layers and spacer layer thickness), table data is prepared that indicates a full width of half maximum corresponding to the each cavity and stored in the memory 13 as a table data file F.

Accordingly, it is possible to recognize readily film structures of cavities \mathring{1} to \mathring{5} corresponding to optimized full width of half maximums W1 to W5, respectively.

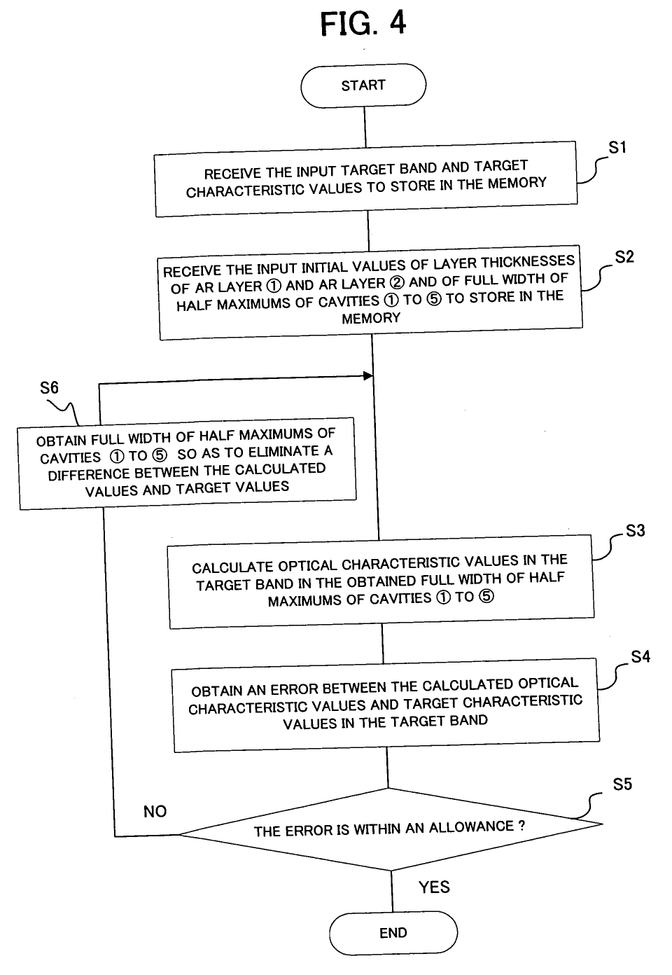

The entire operation of this embodiment will be described below. In addition, this embodiment describes a case of designing a film structure of the five-cavity filter as illustrated in above expression (3). Now referring to FIGS. 2 and 4, processes will be described below for obtaining optimal full width of half maximums so as to design a filter having predetermined optical characteristics.

In designing a multi layer thin film optical filter 1, a designer inputs predetermined wavelength optical characteristics in a predetermined wavelength band of a multi layer thin film optical filter 1 to design, i.e., inputs a target band and target characteristic values in the target band, via the input section 11 in the filter designing apparatus 10.

The computer 12 receives the input target band and target characteristic values of the multi layer thin film optical filter 1 to store in the memory 13 as a target file F2 (FIG. 4; step S1).

Then, the designer inputs into the computer 12 initial values of layer thicknesses of the AR layer \mathring{1} and AR layer \mathring{2} and initial values of full width of half maximums W1 to W5 respectively of cavities \mathring{1} to \mathring{5} in the multi layer thin film optical filter 1 targeted for the design via the input section 11 in the filter designing apparatus 10.

The computer 12 receives the input initial values of layer thicknesses of the AR layer \mathring{1} and AR layer \mathring{2} and of full width of half maximums W1 to W5 respectively of cavities \mathring{1} to \mathring{5} to store in the memory 13 (step S2).

Then, based on film structures of cavities \mathring{1} to \mathring{5} given as the initial values, the computer 12 calculates transmittance that is optical characteristic values in the target band in the film structures, for example, using a matrix calculation equation determined corresponding to the film structures (step S3).

The computer 12 obtains an error between the calculated optical characteristic values and target characteristic values in the target band (step S4), and determines whether or not the obtained error is within an allowance (step S5).

If a result of the determination in step S5 is YES (within the allowance) using the initial values, the initial values are of a combination of optimal full width of half maximums, and a series of processing is finished.

If a result of the determination instep S5 is NO, in other words, when the obtained error exceeds the allowance (upper limit allowable in design specifications), the computer 12 performs processing of step S6 and returns to the processing of step S3.

In step S6, calculations are performed to obtain optimal full width of half maximums of cavities \mathring{1} to \mathring{5} so as to eliminate a difference between the calculated values and target values, using an optimization process such as the Levenberg-Marquardt process, Simplex process and Gauss-Newton process.

Then, when a result of the determination in step S5 is YES (within the allowance) after performing the processing of steps S6-S3-S5-S5 at least once, full width of half maximums W1 to W5 calculated in this loop is determined to be of a combination of optimal full width of half maximums, and a series of calculation processing is finished.

As a result, it is possible to obtain optimal full width of half maximums to design the multi layer thin film optical filter 1 having a film structure with a difference from the target characteristic values within a design allowance in the target band.

An example will be described below of design of a multi layer thin film optical filter that was actually designed by the filter designing scheme (algorithm) based on the processing of steps S1 to S8 in the computer 12 as described above. In addition, the design was carried out with specifications of the multi layer thin film optical filter 1 as described:
Target band: (1) Transmittance wavelength band 1547.5 nm˜1562.5 nm
   Optical characteristic value (transmittance>−0.5 dB)
   (2) Cutoff wavelength band 1530.Onm˜1543.5 nm
      Optical characteristic value (transmittance<−2.5 dB)

### EXAMPLE (Design Example) 1

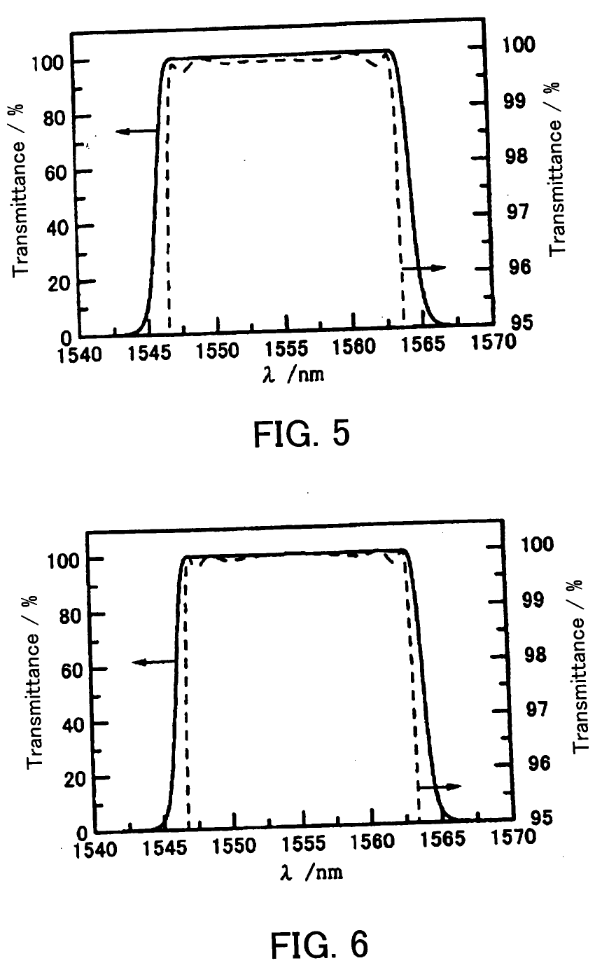

A multi layer thin film optical filter 1a was actually designed (see following expression (5)) using as the optical substrate 2 a substrate with a refractive index of 1.52 in a wavelength of 1550.0 nm, and the filter designing apparatus 10 (film structure designing scheme (algorithm)) of this embodiment while setting the center wavelength λ0 at 1555.0 nm. FIG. 5 shows wavelength dependence (transmittance wavelength characteristics) of transmittance E1 and equivalent admittance A1 that are optical characteristic values of the designed multi layer thin film optical filter 1a.
Air/L′H′L222−2142−2142−2202−2162−2202−2142−2142−222L/Sub (5)

In addition, L′ and H′ represent reflection prevention layers (AR layers) with optical film thicknesses except λ0/4, and Sub represents the substrate 2.

As shown in FIG. 5, the multi layer thin film optical filter 1a designed by the film thickness designing scheme of this embodiment has optical characteristic values such that a difference from the target characteristic values is within a design allowance. Therefore, the ripple appears hardly in the transmittance wavelength characteristics of the multi layer thin film optical filter 1a, and it is understood that development of ripple was suppressed greatly.

In the film thickness designing method of this embodiment, the calculation time (except data input) of the computer 12 was about five minutes, and thus extremely short in the five-cavity multi layer thin film optical filter 1a as illustrated in expression (5) as described above.

### Comparative Example 1

A multi layer thin film optical filter X was actually designed (see following expression (6)) using as the optical substrate 2 a substrate with a refractive index of 1.67 in a wavelength of 1550.0 nm while setting the center wavelength λ0 at 1555.0 nm. FIG. 6 shows wavelength dependence (transmittance wavelength characteristics) of transmittance E2 and equivalent admittance A2 that are optical characteristic values of the designed multi layer thin film optical filter X.
Air/L′H′L222−2122−2142−2182−2162−2182−2142−2122−222L/Sub (6)

The number of combinations of film structures (determined based on patterns of the number of cavities and spacer layer thickness to combine) is about 750,000 that was calculated until the five-cavity multi layer thin film optical filter X as indicated in above expression (6) was derived, and the calculation time (except data input) of the computer 12 was about one day.

As can be seen from FIGS. 5 and 6, the transmittance wavelength characteristics of the multi layer thin film optical filter 1a obtained by using the film structure designing scheme (algorithm) by the filter designing apparatus 10 as described in this embodiment are approximately the same as the transmittance wavelength characteristics of the multi layer thin film optical filter X obtained by using the film structure designing scheme (algorithm) as described in Comparative Example 1.

Meanwhile, it took about one day, a very long time, to calculate the film structure of the multi layer thin film optical filter X using the film structure designing scheme (algorithm) as described in Comparative Example 1. In contrast thereto, it took about five minutes, a very short time, for the filter designing apparatus 10 described in this embodiment to calculate the film structure of the multi layer thin film optical filter 1a using the film structure designing scheme.

In other words, according to this embodiment, it is possible to perform with extreme readiness the film design of the multi layer thin film optical filter 1 capable of significantly suppressing development of ripple in a transmission wavelength band, and to greatly improve the efficiency in designing the multi layer thin film optical filter 1.

### Second embodiment

This embodiment describes designing a film structure of, for example, a 100 G-4skip0 band separator as the multi layer thin film optical filter 1c described in the first embodiment, using a designing scheme different from the designing scheme described in the first embodiment.

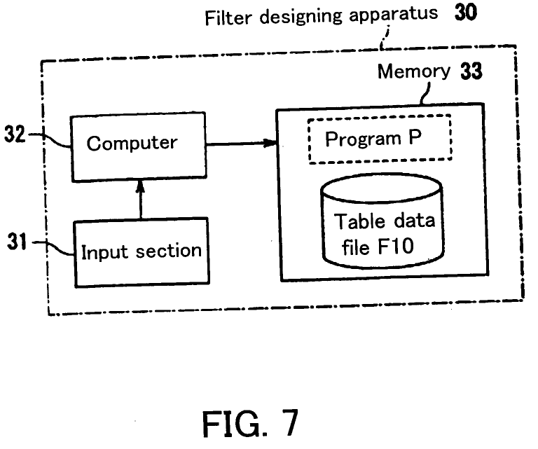

In other words, as illustrated in FIG. 7, a filter designing apparatus 30 is a computer system and provided with an input section 31 for a designer to operate and input information, a computer 32 connected to the input section 31, and a memory 33 as a storage medium which is connected to the computer 32 and beforehand stores a program P1 to execute filter designing processing as described later. In addition, as the storage medium, various storage media are applicable such as a semiconductor memory and magnetic memory.

In this embodiment, the program P1 stored in the memory 33 is different from the program P stored in the memory 13 in the filter designing apparatus 10 as illustrated in FIG. 2, and the table data file F is not stored in the memory 33.

Specific descriptions are given below of the algorithm of the program P1 stored in the memory 33, i.e. the filter designing scheme of this embodiment.

An example is indicated in following expression (7) of a film structure of a first cavity in the multi layer thin film optical filter 1c with the multi-cavity structure (assumed as a nine-cavity structure) indicated in Table 1, expression (4), etc. in the first embodiment.

In addition, in the nine-cavity structure, the nine cavities and coupling layers are arranged symmetrically along the lamination direction, where the first cavity closest to the substrate and the ninth cavity closest to the medium have the same number of layers of a mirror layer portion, same film thickness of a spacer layer of the cavity, same optical film thickness of each refractive index layer constituting each mirror layer of the cavity.

Similarly, the second and eighth cavities, the third and seventh cavities and the fourth and sixth cavities have respective same and symmetrical film structures.
HL HL HL HL HL H xL H LH LH LH LH LH (7)

The first cavity as illustrated in above expression (7) represents a cavity structure of 5x5 (=(HL)⁵HxLH(LH)⁵). In other words, H and L constituting a mirror layer respectively represents an H layer and L layer each with an optical film thickness of (¼) times the center wavelength λ0, and xL represents a spacer layer having an optical film thickness of (2x/4) times the center wavelength λ0.

In this embodiment, each cavity comprised of the mirror layers and spacer layer as described above is represented by a plurality of parameters including the number of layers of the mirror layer of the cavity, a film thickness of the spacer layer of the cavity, and optical film thickness of each refractive index layer constituting each mirror layer of the cavity, and a film structure of each cavity is designed by optimizing the plurality of parameters, P1 to P3 (the number of layers of the mirror layer: P1, optical film thickness of the spacer layer: P2 and optical film thickness of each refractive index layer constituting each mirror layer: P3).

That is, a designer inputs a target band and target characteristic values in the target band of the multi-layer thin film optical filter 1c to design via the input section 31 in the filter designing apparatus 10.

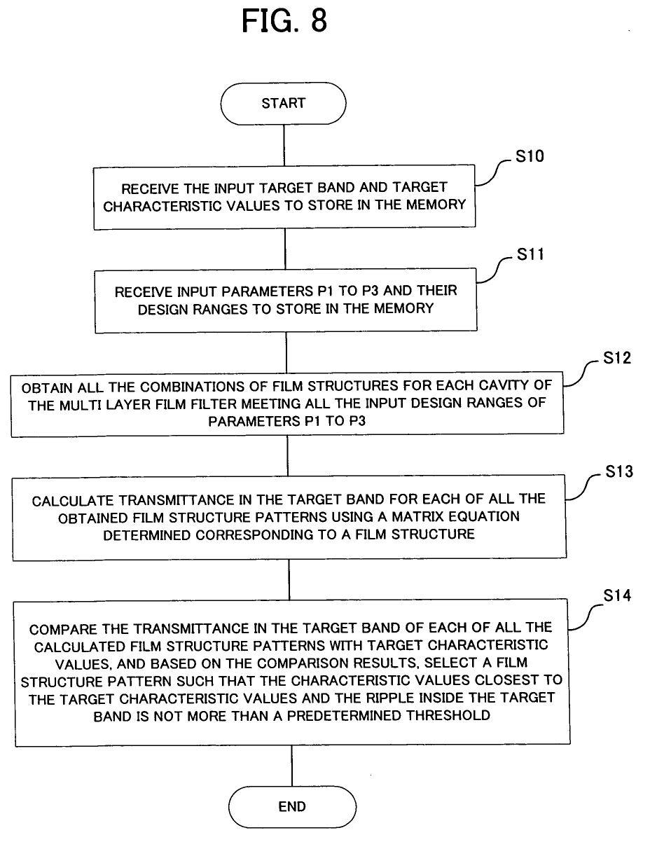

The computer 32 receives the input target band and target characteristic values of the multi layer thin film optical filter lc to store in the memory 33 as a target file F10 (FIG. 8; step S10).

Then, via the input section 31 in the filter design apparatus 30, the designer inputs the number of cavities (for example, assumed as nine in this embodiment) and initial values of parameters P1, P2 and P3 (the number of layers of the mirror layer, optical film thickness of the spacer layer and optical film thickness of each refractive index layer constituting each mirror layer prior to optimization) of the multi layer thin film optical filter 1c targeted for the design (optimization), and further inputs respective design ranges of parameters P1, P2 and P3.

In this embodiment, input are −4 layers to +2 layers with respect to the number of layers prior to optimization input as an initial value as a design range of parameter P1, (2kλ0)/4 (k is an integer ranging from 0 to 5), i.e. 2×0×λ0/4(=OL)˜2×5×λ0/4(=10L) as a design range of parameter 2, and λ0/4(=L or H) or 3λ0/4 (=3L or 3H) as parameter 3.

The computer 32 receives input parameters P1, P2 and P3 and their design ranges to store in the memory 33 (step S11).

Then, the computer 32 obtains all the combinations of film structures for each cavity of the multi layer thin film optical filter lc meeting all the input design ranges of parameters P1 to P3 (step S12).

In other words, the number of combinations of film structures of the first cavity as illustrated in expression (7) is p1 as described below.
HL HL HL H OL H LH LH LH (P1=−2,P2=2×0×λ0/4, P3→all λ0/4) (combination 1)
HL HL HL H 2L H LH LH LH (P1=−2,P2=2×1×λ0/4, P3→all λ0/4) (combination 2)
3HL HL HL H 4L H LH LH L3H (P1=−2,P2=2×2×λ0/4, P3→two:3λ0/4; the others: λ0/4) (combination k)
3H3L 3H3L 3H3L 3H3L 3H3L 3H3L H lOL H 3L3H 3L3H 3L3H 3L3H 3L3H 3L3H (P1=4,P2=2×5×λ0/4, P3→all 3λ0/4) (combination p1)

Similarly, with respect the other cavities, the second to fifth cavities, all combinations (p2 combinations to p5 combinations) meeting the design ranges of parameters P1 to P3 are calculated by the processing of step S12.

In step S12, since the sixth to ninth cavities respectively have film structures symmetrical to those of the first to fourth cavities, the computer 32 only calculates respective combinations (p1 combinations to p5 combinations) of the first to fifth cavities, and obtains combinations of the sixth to ninth cavities (p6 combinations to p9 combinations) from results of the respective combinations (p1 combinations to p5 combinations) of the first to fifth cavities.

Then, using a well-known matrix calculation equation determined corresponding to the film structure, computer 32 calculates transmittance that are optical characteristic values in the target band for each of all the film structure patterns obtained in the processing of step S12, i.e., all the film structure patterns (the total number of combinations =p1×p2×p3×p4×p5×p6×p7×p8×p9) in design ranges of parameters P1 to P3 that the 9-cavity multi layer thin film optical filter 1c is allowed to have (step S13).

Next, the computer 32 compares the transmittance in the target band of each of all the calculated film structure patterns with target characteristic values, and based on the comparison results, selects a film structure pattern such that the characteristic values are in accordance with or the most approximately the target characteristic values and the ripple (transmittance fluctuations) inside the target band (transmittance wavelength band) is not more than a predetermined threshold (for example, the threshold is assumed to be 0.3 dB in this embodiment) (step S14).

By forming a film based on thus selected film structure pattern, it is possible to obtain the multi layer thin film optical filter 1c such that the characteristic values are approximately the target characteristics values in the target band and the ripple is not more than a predetermined threshold.

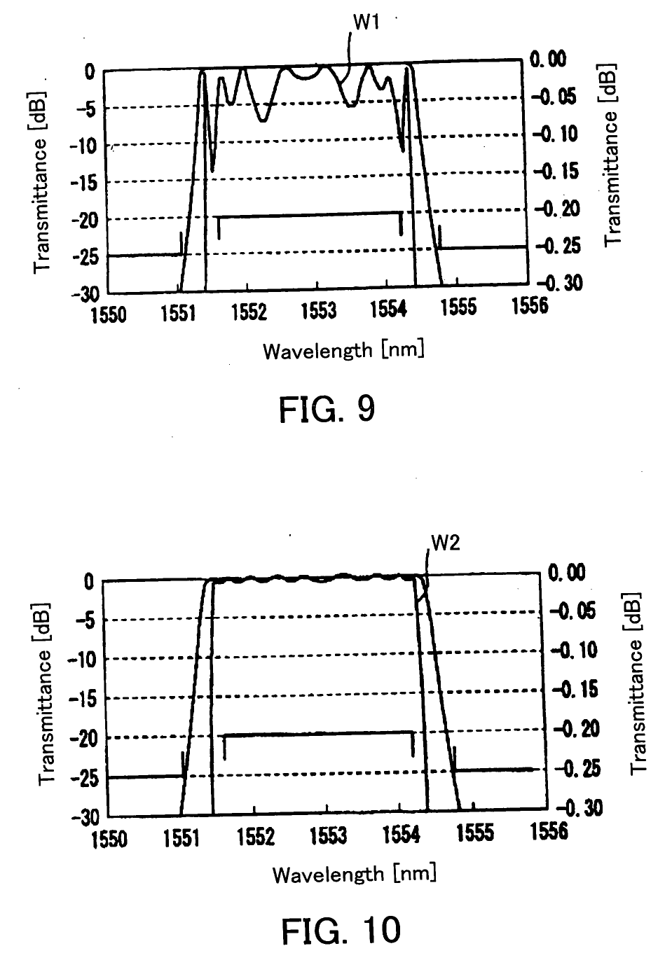

FIG. 9 shows wavelength dependence (transmittance wavelength characteristics) W1 in a multi layer thin film optical filter Y (100 G-4skip0 Band Separator) of multi-cavity structure (nine cavities, 280QW; film forming material of H layer is Ta₂O₅and film forming material of L layer is SiO₂) designed using the conventional film structure designing scheme, in other words, without using the optimization designing scheme based on above-mentioned parameters P1 to P3.

Meanwhile, FIG. 10 shows wavelength dependence W2 in the multi layer thin film optical filter 1c (100 G-4skip0 Band Separator) of multi-cavity structure (nine cavities, 280QW; film forming material of H layer is Ta₂O₅and film forming material of L layer is SiO₂) designed using the film structure designing scheme, in other words, the optimization designing scheme based on above-mentioned parameters P1 to P3.

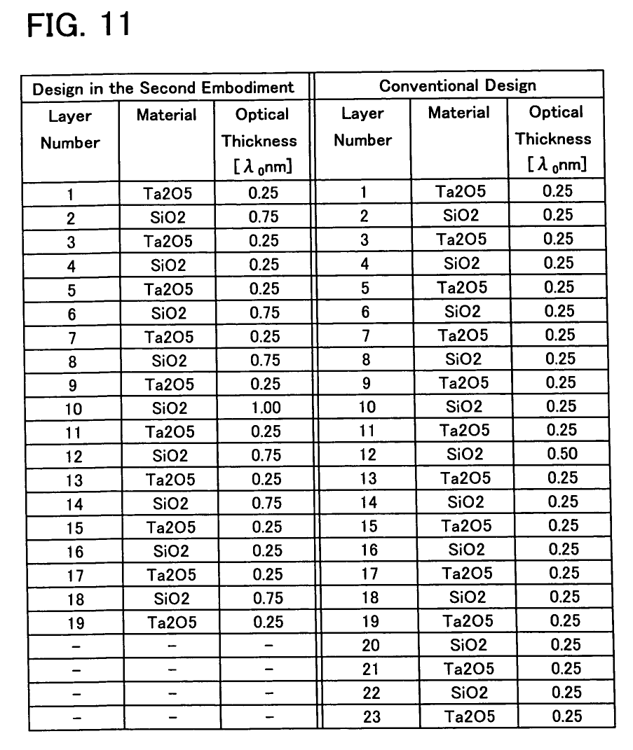

Further, FIG. 11 shows comparison between a film structure of a first cavity of the multi layer thin film optical filter Y using the conventional film structure designing scheme as illustrated in FIG. 9 and a film structure of a first cavity of the multi layer thin film optical filter 1c using the film structure designing scheme of this embodiment as illustrated in FIG. 10.

In FIG. 11, in the first cavity of the multilayer thin film optical filter Y, a mirror layer portion is comprised of the first layer (layer number 1) to the eleventh layer (layer number 11) and the thirteenth layer (layer number 13) to the twenty-third layer (layer number 23), and a spacer layer (cavity layer) is the twelfth layer (layer number 12). In the first cavity of the multi layer thin film optical filter 1c, a mirror layer portion is comprised of the first layer (layer number 1) to the seventh layer (layer number 7) and the ninth layer (layer number 9) to the nineteenth layer (layer number 19), and a spacer layer (cavity layer) is the eighth layer (layer number 8).

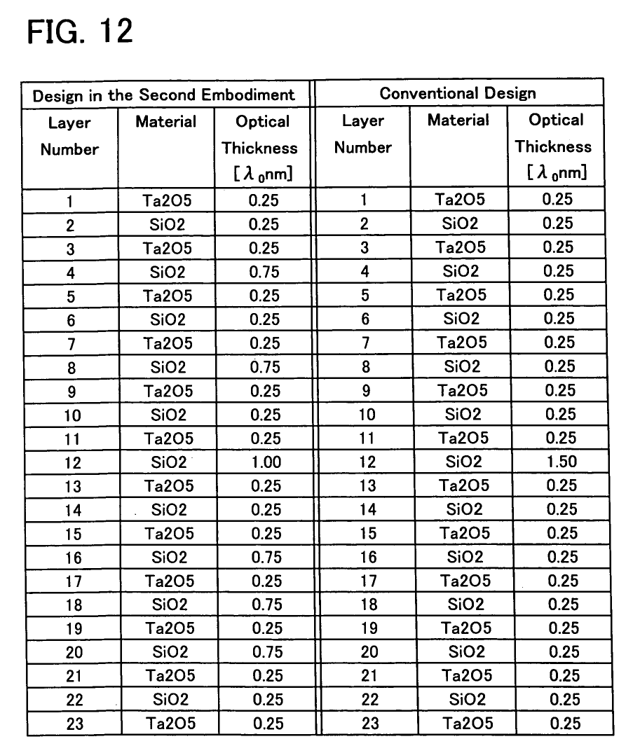

Similarly, FIG. 12 shows comparison between a film structure of a second cavity of the multi layer thin film optical filter Y using the conventional film structure designing scheme as illustrated in FIG. 9 and a film structure of a second cavity of the multi layer thin film optical filter 1c using the film structure designing scheme of this embodiment as illustrated in FIG. 10.

In FIG. 12, in the second cavity of the multi layer thin film optical filter Y, a mirror layer portion is comprised of the first layer (layer number 1) to the eleventh layer (layer number 11) and the thirteenth layer (layer number 13) to the twenty-third layer (layer number 23), and a spacer layer (cavity layer) is the twelfth layer (layer number 12). In the second cavity of the multi layer thin film optical filter 1c, a mirror layer portion is comprised of the first layer (layer number 1) to the eleventh layer (layer number 11) and the thirteenth layer (layer number 13) to the twenty-third layer (layer number 23), and a spacer layer (cavity layer) is the twelfth layer (layer number 12).

As can be seen from FIGS. 9 and 10, the ripple is significantly reduced (about 1/10) in the transmittance wavelength characteristics of the multi layer thin film optical filter 1c designed by the film structure designing scheme of this embodiment, as compared to the transmittance wavelength characteristics of the multi layer thin film optical filter Y designed by the conventional film structure designing scheme.

As described above, according to this embodiment, instead of setting an optical film thickness of each layer of a mirror layer portion constituting each cavity of the multi layer thin film optical filter 1c at a constant value (for example, ¼ times the center wavelength λ0 in the conventional film structure designing scheme), such an optical film thickness is set at ¼ times the center wavelength λ 0 or ¾ times the center wavelength λ 0. Further, the ratio between H/L layers with the optical film thickness of λ 0/4 and H/L layers with the optical film thickness of 3λ0/4 is optimized as well as the total number in a corresponding mirror layer portion and the layer thickness of the spacer layer.

In other words, according to this embodiment, in a mirror layer portion that constitutes each cavity of the multi layer thin film optical filter 1c, the ratio between H/L layers with the optical film thickness of λ0/4 and H/L layers with the optical film thickness of 3λ0/4 can be optimized such that the optical characteristics are in accordance with the target characteristics and that the ripple (transmittance fluctuations) in the target band (transmittance wavelength band) becomes the smallest.

As a result, it is possible to design a multi layer thin film optical filter 1c which has optical characteristics in accordance with or approximately the same as target characteristics and enables an occurrence of ripple to be suppressed greatly, and to further improve the performance of the multi layer thin film optical filter 1c.

In addition, in this embodiment, as described above, parameter P3 that represents an optical film thickness of each refractive index layer constituting the mirror layer portion is a variable taking a value of either λ0/4 or 3λ0/4. However, the present invention is not limited to this constitution.

In other words, for each cavity, by limiting (setting an upper limit) the number of refractive index layers on which an optical film thickness of 3λ0/4 can be set among a plurality of refractive index layers in the mirror layer portion, loads of calculation processing on the computer 12 can be reduced in step S12 where the computer 12 obtains all the combinations of film structures.

The number of cavities, the optical film thickness of a mirror layer portion and others of the multi layer thin film optical filters illustrated in the first and second embodiments are not limited to the illustrative structures, and are capable of being modified in various ways within the scope belonging to the technical idea of the present invention.

For example, in the second embodiment, the design range of each of parameters P1, P2 and P3 is an example thereof, and is capable of being changed according to the type of a filter to design, etc.

In particular, parameter P3 is a variable taking a value of either λ0/4 or 3λ0/4, but may be a variable taking a value of either λ0/4 or 3 λ0m4/4 (m4 is a positive odd number).

Herein, as a typical example of a structure of the multi layer thin film optical filter 1 obtained in the above-mentioned designing scheme, there is a filter with a structure where full width of half maximums of cavities are different from one another except cavities at positions symmetric with respect to the center of lamination.

An actual example will be described below of a multi layer thin film optical filter having seven cavities. Assuming full width of half maximums of the cavities are respectively W0, W1, W2, W3, W4, W5 and W6, in multi layer thin film optical filters of W0-W1-W2-W3-W4-W5-W6 structure, amulti layer thin film optical filter is considered where W1=W6, W1=W5, W2=W4 and W0≠W1≠W2≠W3.

Further, in multi layer thin film optical filters of the aforementioned structure, a filter is considered such that each cavity always contains thin film layers each with the optical film thickness of (λ0)/4 and thin film layers each with the optical film thickness of (3λ0)/4. Furthermore, a filter is considered such that insertion positions of the thin film layers each with the thickness of (3λ0)/4 in each cavity are different between cavities except cavities in positions symmetric with respect to the center of lamination of cavities. It is known both filters as described above exhibit excellent optical characteristics.

An example will be described below of the method of manufacturing a dielectric multi layer thin film optical filter for calculating a cavity structure with a predetermined full width of half maximum with (3λ0)/4 set at an optical layer thickness of a thin film layer constituting a mirror layer.

A method will be described below of calculating a cavity structure with a full width of half maximum of 2.115 nm.

Herein, instead of calculating all the actual solutions existing, calculation is carried out under two restrictions as described below. The restriction items are provided in consideration of performance of the manufacturing apparatus (such as a film thickness, the number of layers, film forming time, etc. of a filter that the apparatus can manufacture), for the purpose of calculating optimal actual solutions in a range enabling actual manufacturing. Specifically, following conditions are added. The mirror layer group has 15 or less layers (7 pairs or less), and the spacer layer has either 2L, 4L or 6L.

Primary Calculation

Structures are first calculated where full width of half maximums are near 2.115 nm (for example, within ±50%) without optical film thickness of 3 λ0/4 being set within the restriction items as described above. Table 2 shows the results.

TABLE 2

| | The | | | | |
|---|---|---|---|---|---|
| | number | | | Cavity | |
| | of | | Cavity | structure | Full width of |
| | mirror | Spacer | structure | expression | half maximum |
| No. | pairs | layer | expression | representation | [nm] |
| 1 | 6 | 6L | (HL)⁶H6LH | 666 | 1.2955 |
| | | | (HL)⁶ | | |
| 2 | 6 | 4L | (HL)⁶H4LH | 646 | 1.6060 |
| | | | (HL)⁶ | | |
| 3 | 6 | 2L | (HL)⁶H2LH | 626 | 2.1124 |
| | | | (HL)⁶ | | |
| 4 | 5 | 6L | (HL)⁵H6LH | 565 | 2.7696 |
| | | | (HL)⁵ | | |
| 5 | 5 | 4L | (HL)⁵H4LH | 545 | 3.4376 |
| | | | (HL)⁵ | | |

Secondary Calculation

With respect to five types of combinations obtained in the primary calculation as described above, 3λ0/4 is set as an optical film thickness of a thin film layer constituting a mirror layer, the full width of half maximums are adjusted. Herein, in order to reduce loads on the calculation and prevent the film thickness from increasing excessively, the number of thin film layers of 3λ0/4 is limited to six (three layers in the mirror layer group at one side of a spacer layer) for each cavity. The structure of mirror layer group is symmetric with respect to the spacer layer.

Structure Representation Method

A structure representation method will be described below. In the case of a structure expression of [HL HL HL 3HL HL H] 2L [H LHL3HLHLHLH], representation is “525−64” (mirror layer 5 pairs−spacer layer 2L−mirror layer 5 pairs 3λ0/4 position “64”)

The representation of 3λ0/4 position is carried out as described below.

Eleventh layers of the mirror layer group on one side are represented in 11-digit binary, assuming a layer of λ0/4 as 0, a layer of 3λ0/4 as 1, and a layer furthest from the spacer layer as a first digit.

The binary representation of the mirror layer group on one side is “00001000000”. “64” is obtained by converting the binary representation into decimal numbers.

With respect to each of the combinations calculated in the primary calculation, all combinations are calculated such that the mirror layer group has either of one to three thin film layers each with the optical film thickness of 3λ0/4. Among the structures calculated asdescribedabove, Table 3 shows ten combinations of structure examples in the order in which the full width of half maximum is close to 2.115 nm.

TABLE 3

| | Structure | Full width of half |
|---|---|---|
| No. | representation | maximum [nm] |
| 1 | 565-1056 | 2.1156 |
| 2 | 565-1044 | 2.1158 |
| 3 | 565-768 | 2.1159 |
| 4 | 565-672 | 2.1168 |
| 5 | 626-0 | 2.1124 |
| 6 | 565-769 | 2.1083 |
| 7 | 565-1057 | 2.1080 |
| 8 | 565-1042 | 2.1230 |
| 9 | 565-1048 | 2.1061 |
| 10 | 626-1 | 2.1048 |

Among the cavities as shown in Table 3, the structure of 565-1056 described in the uppermost line is an actual solution closest to an ideal solution (herein, a cavity with the full width of half maximum of 2.115 nm).

For reference, structures are shown below of three actual solutions closest to the ideal solution.
565-1056: [3HL HL H3L HL HL H] 6L [H LH LH 3LH LH L3H]
565-1044: [3HL HL HL 3HL 3HL H] 6L [H L3H L3H LH LH L3H]
565-0768: [H3L 3HL HL HL HL H] 6L [H LH LH LH L3H 3LH]

Specific examples will be described below of multi layer thin film optical filter having optimal cavities obtained by the aforementioned method whereby the ripple of transmittance is reduced. Table 4 shows structures of ideal solutions and actual solutions of multi layer thin film optical filter comprised of seven cavities. Herein, each of the ideal solutions is a cavity of structure obtained by the optimization calculation with the full width of half maximum as a parameter. Meanwhile, each of the actual solutions is a multi layer thin film optical filter configured of seven laminated cavities each of which has characteristics close to those of an ideal cavity as much as possible and can be designed and manufactured actually.

TABLE 4

| | Ideal | | | |
|---|---|---|---|---|
| | solution | Actual solution | | |
| Cav- | Full width | Full width | | |
| ity | of half | of half | Structure | Structure |
| No. | maximum [nm] | maximum [nm] | expression | index |
| 1 | 31.97988 | 32.10316 | 3H3L HL H 4LH | 242-3 |
| | | | LH 3L3H | |
| 2 | 18.45625 | 18.61595 | 3HL H3L HL H2L | 323-9 |
| | | | H LH 3LH | |
| | | | L3H | |
| 3 | 13.57641 | 13.83943 | 3HL HL 3HL H4L | 343-17 |
| | | | H L3H LH | |
| | | | L3H | |
| 4 | 15.04779 | 15.32724 | 3H3L HL HL H4L | 343-3 |
| | | | H LH LH | |
| | | | 3L3H | |
| 5 | 13.57641 | 13.83943 | 3HL HL 3HL H4L | 343-17 |
| | | | H L3H LH | |
| | | | L3H | |
| 6 | 18.45625 | 18.61595 | 3HL H3L HL H2L | 328-9 |
| | | | H LH 3LH | |
| | | | L3H | |
| 7 | 31.97988 | 32.10316 | 3H3L HL H 4LH | 242-3 |
| | | | LH 3L3H | |

Herein, the first and seventh cavities have the same structure, and so do the second and sixty cavities and the third and fifth cavities, where the entire structure is symmetric with respect to the fourth cavity positioned at the center.

In the ideal solutions, full width of half maximums are different between cavities except cavities in symmetrical positions. In almost cases of ideal solution, full width of half maximums of cavities are not the same as others except cavities in symmetrical positions. This is because the full width of half maximum of each cavity is optimized to suppress the ripple.

Full width of half maximums of cavities of actual solutions having full width of half maximum characteristics close to the ideal solutions are also different between cavities except cavities in symmetrical positions. In structures, cavities except those in symmetrical positions do not have the same number of pairs, the same space layer thickness and same insertion position of a layer of 3λ0/4.

In the case where full width of half maximums of some two cavities of ideal solutions are very close to each other, the actual solutions may have the same values (same structure and same full width of half maximum). Even in such a case, all the other cavities do no have the same structure.

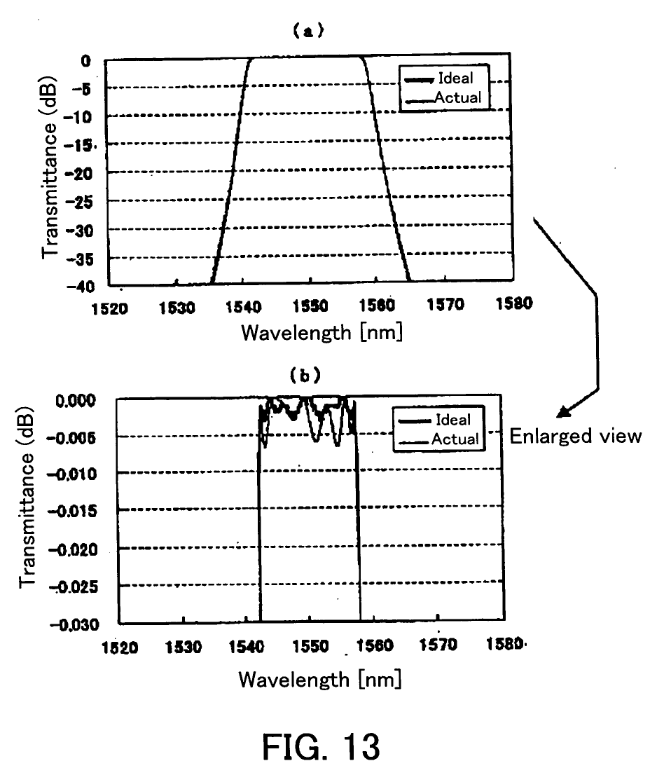

Each of FIGS. 13(a) and 13(b) shows a waveform in an ideal solution and a waveform in an actual solution of transmittance in a predetermined wavelength band. FIG. 13(b) shows an enlarged chart. It is understood that the ideal solution and actual solution exhibit very similar characteristics and are almost in accordance with one another. Further, as can be seen from the figures, it is possible to obtain characteristics such that the ripple is extremely small.

In order to achieve steeper band separation characteristics with a wider band in BPF, band-separator, C/L, B/R, LWPF, SWPF, etc., it is necessary to increase the number of layers and the number of cavities. However, as the number of cavities increases, the ripple tends to occur in a transmittance band. Therefore, the ripple can be reduced by adjusting the number of layers of a mirror layer group and the film thickness of a cavity layer.

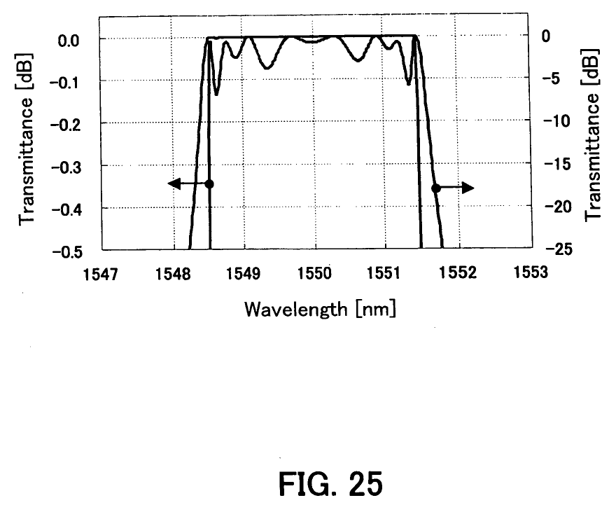

However, there are cases that the ripple cannot be limited to a small value (for example, 0.02 dB or less) in a design stage only by adjusting the number of layers of a mirror layer group and the film thickness of a cavity layer (see FIG. 25). In a 4skip0-100 GHz filter as illustrated in FIG. 25, the ripple is reduced by adjusting the number of layers of 9-cavity design mirror layer with nine cavities laminated and the film thickness of the spacer layer, but it is difficult to decrease the ripple to 0.1 dB or less. Therefore, a multi-layer spacer layer comprised of a plurality of materials will be described below, instead of using a spacer layer comprised of a single layer.

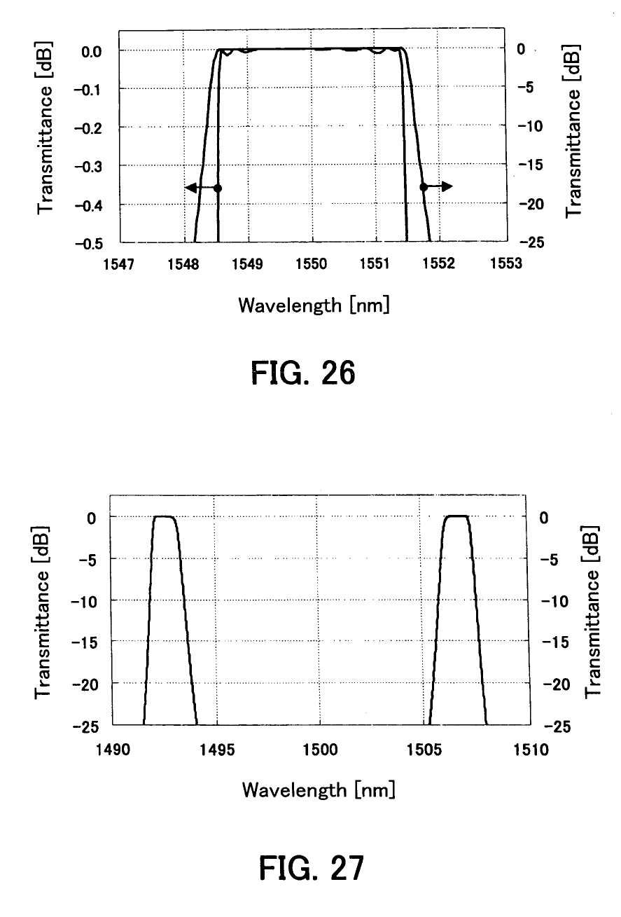

In other words, the low-ripple design as shown in FIG. 26 is achieved by optimizing the structure of the spacer layer

Further, the ripple sometimes occurs when light is incident obliquely, even when the ripple is reduced when light is incident vertically. Generally, since a band-pass filter is used while the light is incident obliquely at some angles, the ripple occurring in the oblique incidence becomes a problem also.

In a cavity constituting a multi-cavity structure, wavelength characteristics shift to shorter wavelengths in the case where light is obliquely incident than in the case where light is vertically incident. The shift amount varies with the structure (=design) of the cavity. Therefore, it is intended to prevent the ripple from occurring in oblique incidence by configuring the multi-cavity structure so that the shift amount of each cavity is almost unique.

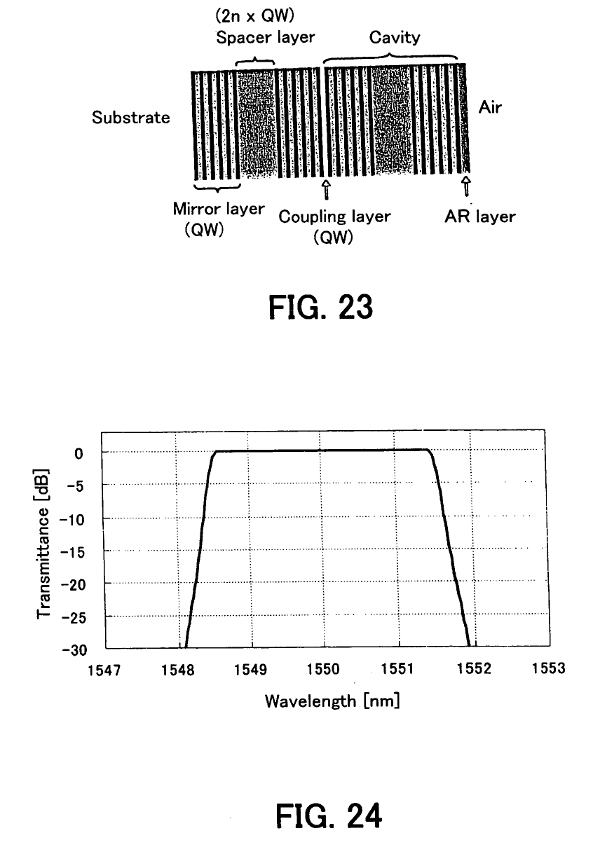

In the structure as shown in FIG. 23, the number of transmittance bands is limited to one. FIG. 24 shows an example of transmittance waveform of the band-pass filter with the structure as shown in FIG. 23. Accordingly, it is difficult to collectively separate a plurality of bands that are not continuous, or correctively separate non-continuous wavelengths of WDM signal.

Therefore, the spacer layer that used to have a single layer is configured in multi-layer structure. For example, a multi-cavity structure such that each spacer layer is comprised of two cavities enables two transmittance bands as shown in FIG. 27. A multi-cavity structure such that each spacer layer is comprised of three cavities enables three transmittance bands.

Hereinafter, a structure of a multi layer film is described by a structure expression.

It is assumed that H and L are respectively are a QW layer of high-refractive index material and a QW layer of low-refractive index material. For example, representation of 2H or HH indicates that the film thickness of the high-refractive index material is 2QW (=2λ/4). (LH)² represents LHLH. (LH)² H 2 L represents LHLHHLL.

The low-ripple design will be described below.

Herein, as an example, a band-pass filter is described that satisfies characteristics such that the transmittance bandwidth is 30 nm or more and the cutoff width is 45 nm or less.

Ideal design will be described first.

FIG. 33 shows an ideal solutionof the band-pass filter satisfying characteristics such that the transmittance bandwidth is 30 nm or more and the cutoff width is 45 nm or less. Table 5 shows full width of half maximums of the ideal design.

TABLE 5
Full width of half maximum of ideal solution

| | Cavity | | | | | | | | |
|---|---|---|---|---|---|---|---|---|---|
| | \mathring{1} | \mathring{2} | \mathring{3} | \mathring{4} | \mathring{5} | \mathring{6} | \mathring{7} | \mathring{8} | \mathring{9} |
| Full width | 64.34691 | 39.45689 | 27.88056 | 31.24946 | 26.09056 | 31.24946 | 27.88056 | 39.45689 | 64.34691 |
| of half | | | | | | | | | |
| maximum [nm] | | | | | | | | | |

The design of each cavity will be describe below.

Determination of Primary Candidates

The design is started from the fifth cavity. First, the thickness of the spacer layer and the number of layers of mirror layer are specified. As the thickness of the spacer layer is increased, the degree of modification freedom is increased (the degree of design freedom is increased), but the calculation amount increases unless a range of some extent is determined. Therefore, the thickness is limited to a range of 8QW to 12QW.

Next, the number of layers of mirror layer is determined that is needed when the thickness of the spacer layer ranges from 8QW to 12QW.

Primary candidates are determined such that the full width of half maximum is 40% to 160% of the ideal design in a cavity with a general structure where the spacer layer is a single layer. Since the ideal design value of the full width of half maximum of the fifth cavity is 26.9056 nm, primary candidates are four types of structures as shown in Table 6. In addition, a transmittance waveform is calculated in a structure of which the both sides are media, for example, Air/(HLHLH LL HLHLHH)/Air, and the full width of half maximum of the waveform is calculated.

TABLE 6
Primary candidates for the fifth cavity

| | | Full width of half |
|---|---|---|
| | Primary candidate | maximum [nm] |
| 1 | HLHLHLH 8L HLHLHLH | 10.9339 |
| 2 | HLHLH 12L HLHLH | 18.1279 |
| 3 | HLHLH 10L HLHLH | 20.7935 |
| 4 | HLHLH 8L HLHLH | 24.3812 |

Selection of Secondary Candidates

Next, in structures of the primary candidates, the spacer layer is modified. Multi-layer structures that can be configured with 8QW are all listed in the case where the spacer layer is 8L. In addition, in order to reduce the calculation amount, the spacer layer is limited in structure to symmetrical. Therefore, 16 types are obtained as available structures. Table 17 shows the available 16 types of structures.

TABLE 7
Symmetrical structures available in 8QW

| | | | |
|---|---|---|---|
| LLLHHLLL | LHHLLHHL | HLLHHLLH | HHLHHLHH |
| LLHLLHLL | LHHHHHHL | HLHLLHLH | HHHLLHHH |
| LLHHHHLL | HLLLLLLH | HLHHHHLH | HHHHHHHH |
| LHLLLLHL | LHLHHLHL | HHLLLLHH | LLLLLLLL |

The structures of the spacer layer and the mirror layers are combined. Modifying the first structure of “HLHLHLH 8L HLHLHLH” of the primary candidates results in “HLHLHLH (LLLHHLLL) HLHLHLH, HLHLHLH (LLHLLHLL) HLHLH, . . . ”, and full width of half maximums in all the structures are calculated.

Similarly, the spacer layer of the second structure of “HLHLH 12LHLHLH” of the primary candidates is modified, thus all the structures of the primary candidates are modified, and full width of half maximums are calculated on all the available patterns.

Finally, three secondary candidates are selected in the order in which the full width of half maximum is close to the ideal design value of 26.9056 nm. Table 8 shows structures and full width of half maximums of secondary candidates.

TABLE 8
Secondary candidates for the fifth cavity

| | | Full width of | |
|---|---|---|---|
| | | half | Wavelength |
| | Structure of secondary | maximum | shift at 2° |
| | candidate | [nm] | [nm] |
| 1 | HLHLH(LLHLHLLHLHLL)HLHLH | 26.2034 | −0.25694 |
| 2 | HLHLH(LLHHHLLHHHLL)HLHLH | 26.1126 | −0.26971 |
| 3 | HLHLH(LLHLHHHHLHLL)HLHLH | 25.5392 | −0.25024 |

Design of the Fourth and Sixth Cavities

In the same way as in the fifth cavity, secondary candidates for the other cavities are selected. In the ideal design of this time, since the multi-cavity structure is limited to symmetrical structures, it is considered that cavities in symmetrical positions such as the fourth and sixth cavities, third and seventh cavities, etc. have the same structure.

The ideal design value of the full width of half maximum of the fourth and sixth cavities is 31.24946.

TABLE 9
Secondary candidates for the fourth and sixth cavities

| | | Full width of | Wavelength |
|---|---|---|---|
| | Structure of secondary | half maximum | shift at 2° |
| | candidate | [nm] | [nm] |
| 1 | HLHL(HHHHHHHHHH)LHLH | 31.1667 | −0.09245 |
| 2 | HLHL(HHHHLHHLHHHH)LHLH | 30.7247 | −0.12125 |
| 3 | HLHL(HHHHLLLLHHHH)LHLH | 29.7012 | −0.15333 |

Selection of Optical Design

Similarly, secondary candidates are selected on all the cavities. Transmittance characteristic are calculated on all the multi-cavity patterns configured using the structures of selected secondary candidates. Structures with the small ripple are selected from among the secondary candidates, and determined as the optimal design. Table 10 shows the optimal design.

TABLE 10

| | | | | Wave- |
|---|---|---|---|---|
| | | Cou- | Half-value | length |
| Cav- | | pling | breadth | shift at 2° |
| ity | Structure | layer | [nm] | [nm] |
| AR | 1.32L 0.32H | — | — | |
| 1 | HLH(LLHLHHHHLHLL)HLH | L | 64.41 | −0.19756 |
| 2 | HLHL(HHLHHHHLHH) | L | 39.33 | −0.22546 |
| | LHLH | | | |
| 3 | HLHL(HHLLHLLHLLHH)LHLH | L | 27.13 | −0.30757 |
| 4 | HLHL(HHHHHHHHHH)LHLH | L | 30.37 | −0.20808 |
| 5 | HLHLH(LLHLLLLHLL) | L | 25.53 | −0.35052 |
| | HLHLH | | | |
| 6 | HLHL(HHHHHHHHHH)LHLH | L | 30.37 | −0.20808 |
| 7 | HLHL(HHLLHLLHLLHH)LHLH | L | 27.13 | −0.30757 |
| 8 | HLHL(HHLHHHHLHH)LHLH | L | 39.33 | −0.22546 |
| 9 | HLH(LLHLHHHHLHLL)HLH | — | 64.41 | −0.19756 |

Substrate

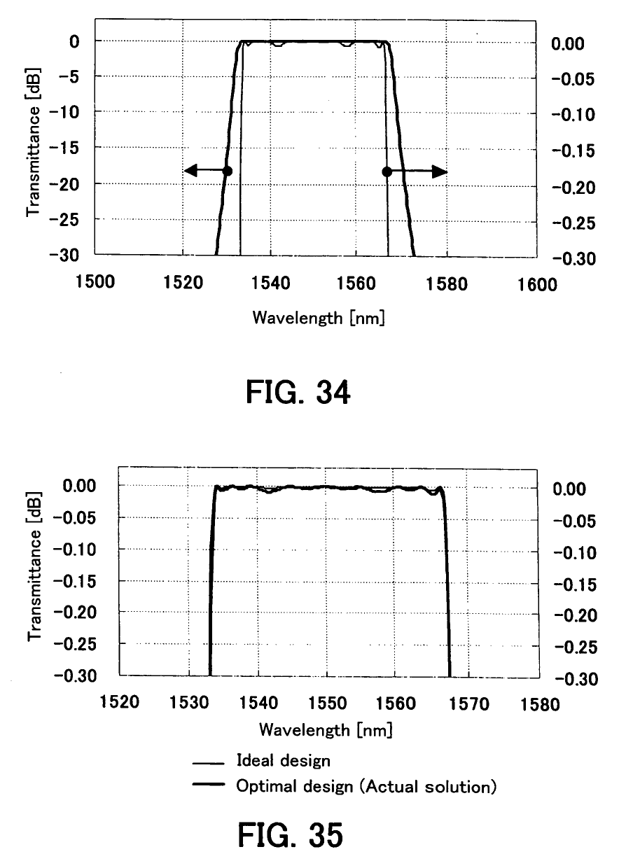

The actual filter structure is Air/1.32L0.32H(1cavity)L(2cavity)L(3cavity)L . . . L(8cavity)L(9cavity)/substrate.
Two layers on the medium (air) side server as AR coat, and film thicknesses of the layers are adjusted so that the transmittance from the substrate side is almost 100%. FIGS. 34 and 35 show waveforms of the optimization design. As can be seen from the figures, the actual design fairly close to the ideal design is obtained. The ripple in the transmittance band is limited to O.OldB or less.
Reduction In Ripple In Oblique Incidence
Specific Example of Reduction In ripple

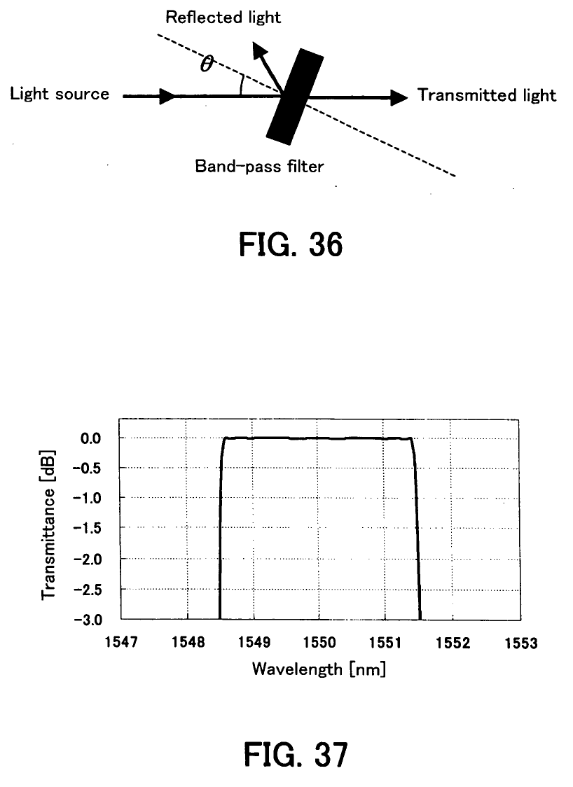

As an example, a band-pass filter is described such that the transmittance bandwidth is 2.9 nm and the cutoff bandwidth is 3.7 nm. As shown in FIG. 36, it is general that transmittance characteristics and reflection characteristics are both used in a band-pass filter. Therefore, the band-pass filter requires no occurrence of ripple in oblique incidence.

FIG. 37 shows a waveform of design of a band-pass filter. Table 11 shows full width of half maximums of cavities constituting the design. The design has a multi-cavity structure comprised of nine cavities.

TABLE 11
Full width of half maximum characteristics

| | Full width of half maximum |
|---|---|
| 1 Cavity | 4.498 nm |
| 2 Cavity | 2.025 nm |
| 3 Cavity | 1.952 nm |
| 4 Cavity | 2.492 nm |
| 5 Cavity | 1.790 nm |
| 6 Cavity | 2.492 nm |
| 7 Cavity | 1.952 nm |
| 8 Cavity | 2.025 nm |
| 9 Cavity | 4.498 nm |

The values of full width of half maximums as shown in Table 11 indicate characteristics of the actual design. For example, 2 Cavity is represented by HLHLHLHLH(16L)HLHLHLHLH.

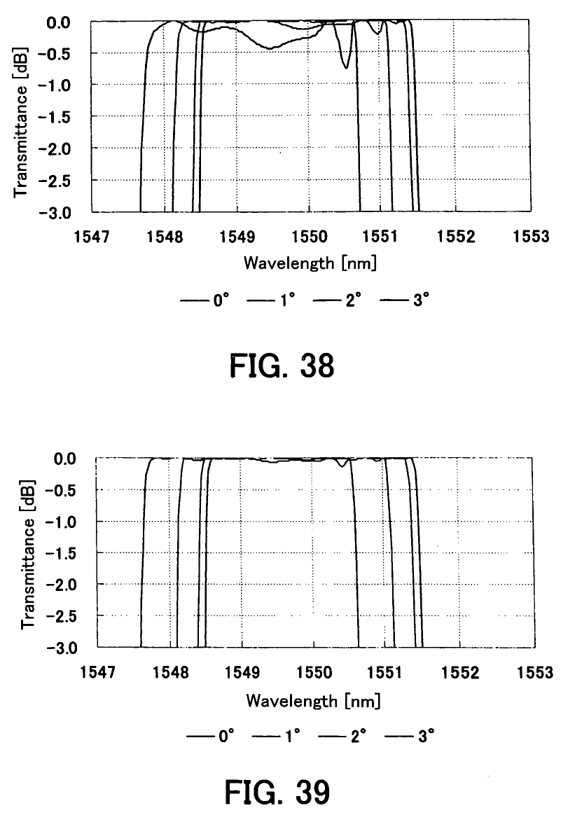

FIG. 38 shows oblique incident characteristics when light is passed through the filter inclined at angles of 0° to 3°.

It is understood that the ripple in the transmittance band increases as the angle is increased. The ripple on 0° incidence is 0.02 dB or less, while reaching 0.75 dB on 3° incidence. This is because oblique incident characteristics are different between cavities that constitute the multi-cavity structure.

Table 12 shows a wavelength shift amount when each cavity is inclined at an angle of 2° from 0°.

TABLE 12
Full width of half maximum characteristics

| | Wavelength shift at 2° |
|---|---|
| 1 Cavity | −0.40944 nm |
| 2 Cavity | −0.43911 nm |
| 3 Cavity | −0.41364 nm |
| 4 Cavity | −0.31317 nm |
| 5 Cavity | −0.4177 nm |
| 6 Cavity | −0.31317 nm |
| 7 Cavity | −0.41364 nm |
| 8 Cavity | −0.43911 nm |
| 9 Cavity | −0.40944 nm |

It is understood from Table 12 that the fourth and sixth cavities have larger wavelength shift amounts than the other cavities.

Table 13 shows the design where the fourth and sixth cavities are changed. The changed fourth and sixth cavities have structures such that the wavelength shift amounts are larger on the negative side (on the short wavelength side) than those in the original design. A structure of the cavity can be designed by the method as described above. With respect to the wavelength shift characteristics, structures are designed by the method as described above, wavelength shift amounts are calculated, and a structure is selected such that the wavelength shift amount is close to a desired value and the full width of half maximum is close to the ideal design.

TABLE 13
Design where the fourth and sixth cavities are changed

| | Full width of | Wavelength shift at |
|---|---|---|
| | half maximum | 2° |
| 1 Cavity | 4.498 nm | −0.40944 nm |
| 2 Cavity | 2.025 nm | −0.43911 nm |
| 3 Cavity | 1.952 nm | −0.41364 nm |
| 4 Cavity | 2.458 nm | −0.39918 nm |
| 5 Cavity | 1.790 nm | −0.4177 nm |
| 6 Cavity | 2.458 nm | −0.39918 nm |
| 7 Cavity | 1.952 nm | −0.41364 nm |
| 8 Cavity | 2.025 nm | −0.43911 nm |
| 9 Cavity | 4.498 nm | −0.40944 nm |

FIG. 39 shows oblique incident characteristics of the design with the fourth and sixth cavities changed. It is understood that the ripple in oblique incidence is reduced as compared to the structure where the fourth and sixth cavities are not changed. The ripple is limited to about 0.1 dB even at 3° incidence.

Quantitative Evaluation of Oblique Incident Characteristics of Cavity

When a band-pass filter is designed in multi-cavity structure, by determining each cavity structure as described below, it is possible to reduce the ripple in oblique incidence.

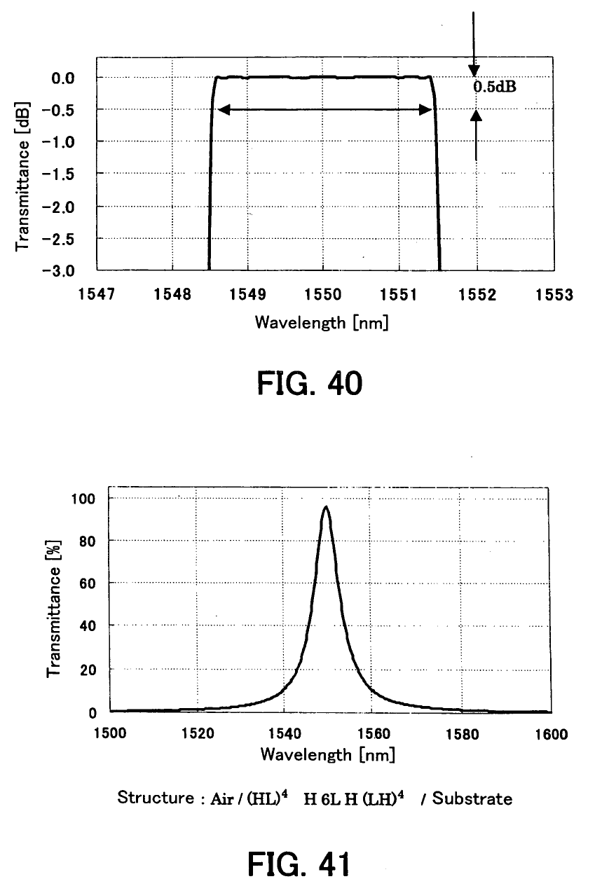

It is assumed that the incident angle is θ when a band-pass filter with a multi-cavity structure is used, and 0.5 dB width is W in a transmittance waveform of the multi-cavity structure in ° incidence. FIG. 40 shows 0.5 dB width.

It is further assumed that S(i) (i is an integer ranging from 1 to N) is a wavelength shift amount occurring while the incident angle is changed from 0° to θ in transmittance characteristics (or reflection characteristics) of an ith cavity in the multi-cavity structure comprised of N cavities.

d is assumed to be a difference between the maximum value and minimum value among N wavelength shift amounts, S(1), S(2), . . . , S(N). Each cavity is designed so that ratio R of d to W, i.e. R=100×(d/W) [%] is 2% or less.

By thus designing each cavity, it is possible to reduce the ripple in oblique incidence.

In the case of the band-pass filter as described above, R is 4.3% before the fourth and sixth cavities are changed, and R is reduced to 1.3% by changing the fourth and sixth cavities.

Band Pass Filter With A Plurality of Transmittance Bands

Cavity Structure

FIG. 41 shows a general cavity structure and transmittance characteristics of the structure. The use of a single cavity with such characteristics achieves a band-pass filter having a single transmittance band. Further, by laminating such acavity via a coupling layer to be a multi-cavity structure, it is possible to manufacture a filter having a single flat transmittance band and steep cutoff characteristics.

Double Cavity Structure

It is possible to manufacture a band-pass filter having a plurality of transmittance bands by forming spacer layer 6L of the cavity (HL)⁴H 6L (LH)⁴ as shown in FIG. 41 into a multi-layer structure, and thus forming a second multi-cavity structure in the spacer layer.

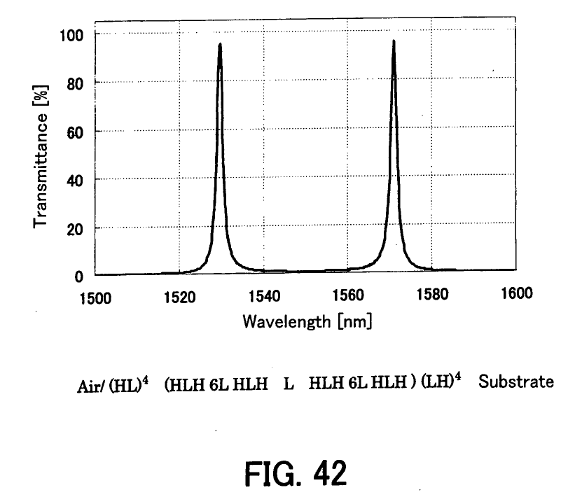

FIG. 42 shows a structure and transmittance waveform in the case where a spacer layer has a multi-cavity structure comprised of two cavities.

In the structure as shown in FIG. 42, a multi-cavity structure (HLH 6L HLH L HLH 6L HLH) comprised of two laminated cavities each of (HLH 6L HLH) is sandwiched between two mirror layers comprised of eight layers.

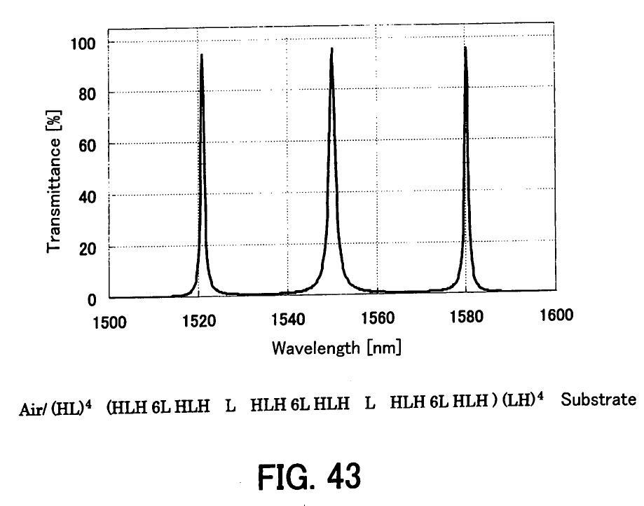

FIG. 43 shows a structure and transmittance waveform in the case where a spacer layer has a multi-cavity structure comprised of three cavities.

In the structure as shown in FIG. 43, a multi-cavity structure (HLH 6L HLH L HLH 6L HLH L HLH 6L HLH) comprised of three laminated cavities each of (HLH 6L HLH) is sandwiched between two mirror layers comprised of eight layers.

By thus replacing a spacer layer of a single cavity with a spacer layer of a multi-cavity structure, it is possible to manufacture a band-pass filter having a plurality of transmittance bands.

An original cavity is referred to as a first cavity, multi-cavity constituting a spacer layer in the first cavity is referred to as second multi-cavity, and each cavity constituting the second multi-cavity is referred to as a second cavity.

The number of transmittance bands is determined by the number of second cavities constituting the second multi-cavity. When the second multi-cavity is comprised of two second cavities, two transmittance bands are obtained.

The transmittance bandwidth is narrowed as the number of mirror layers of the first cavity increases, while the transmittance bandwidth is widened as the number of mirror layers decreases.

Intervals between a plurality of transmittance bands are narrowed as the number of mirror layers constituting the second cavity increases or the spacer layer constituting the second cavity is thickened, while intervals between a plurality of transmittance bands are widened as the number of mirror layers decreases or the spacer layer constituting the second cavity is thinned.

By providing a multi-cavity structure comprised of a plurality of laminated first cavities, it is possible to produce a band-pass filter having a flat transmittance band and steep cutoff characteristics. As the number of first cavities increases, the transmittance band is widened and the cutoff characteristics are steeper.

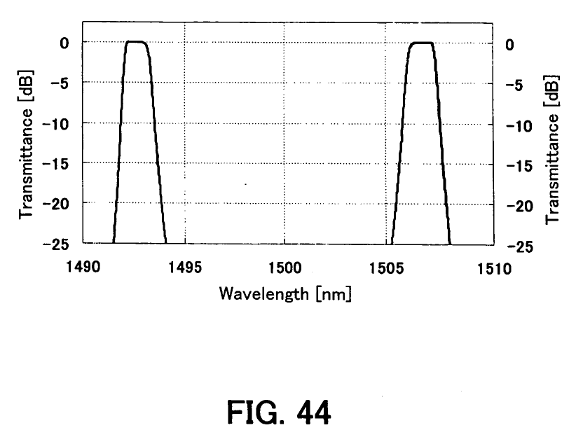

FIG. 44 shows an example of a multi-cavity structure having four laminated first cavities in each of which a second multi-cavity is comprised of two second cavities. Table 14 shows the structure.

TABLE 14
Structure of a band-pass filter having two transmittance
bands

| Cavity | Structure |
|---|---|
| AR | 1.32L 0.32H |
| \mathring{1} | (HL)²((HL)³H2LH(LH)³)²(LH)²(L) |
| \mathring{2} | (HL)³((HL)³H2LH(LH)³)²(LH)³(L) |
| \mathring{3} | (HL)³((HL)³H2LH(LH)³)²(LH)³(L) |
| \mathring{4} | (HL)²((HL)³H2LH(LH)³)²(LH)²(L) |

Substrate

Multi-cavity Structure

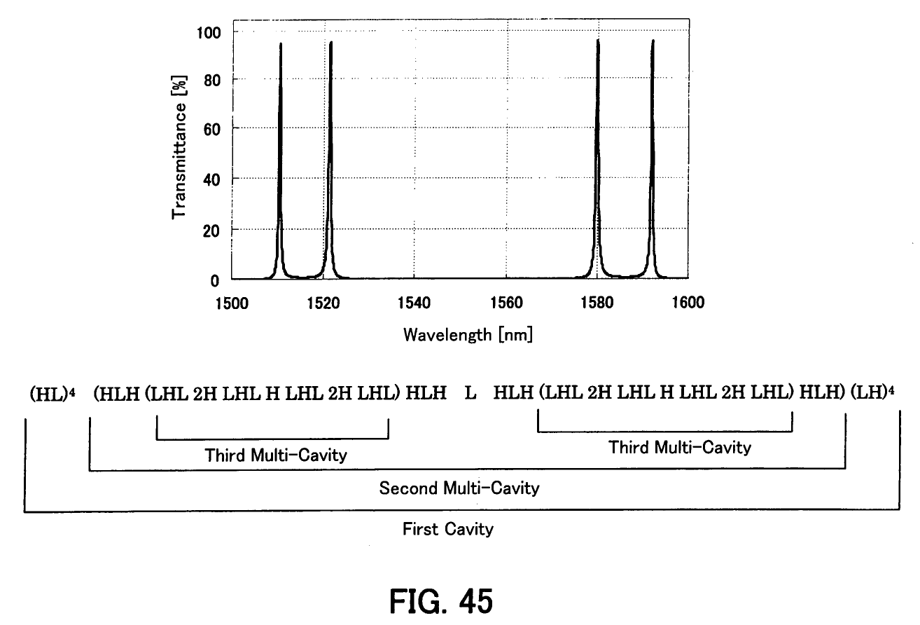

FIG. 45 shows transmittance waveforms and a structure of a triple cavity structure where a spacer layer constituting a second cavity has a multi-cavity structure.

By thus modifying a first-cavity structure into a multi-cavity structure, it is possible to manufacture a band-pass filter having an arbitrary transmittance band.

As described above, according to the present invention, it is possible to reduce the ripple.

In other words, by forming a spacer layer of each cavity constituting a multi-cavity structure into a multi-layer structure, since it is possible to adjust (optimize) each cavity characteristics, it is possible to reduce the ripple in a transmittance band.

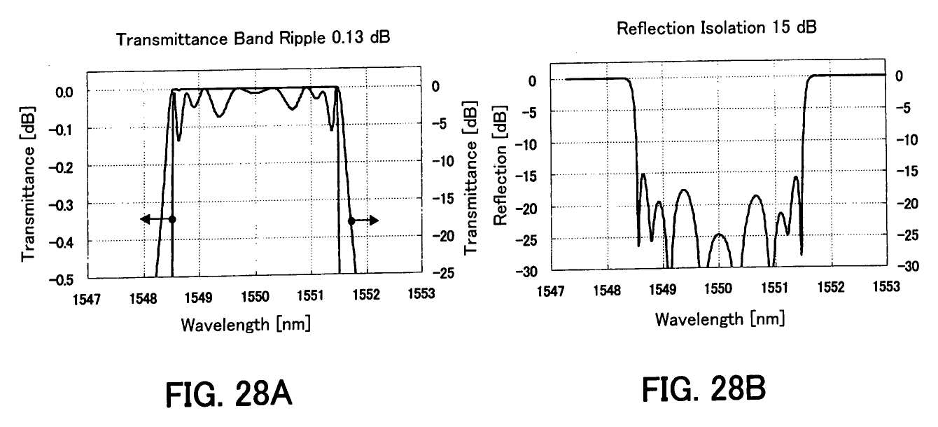

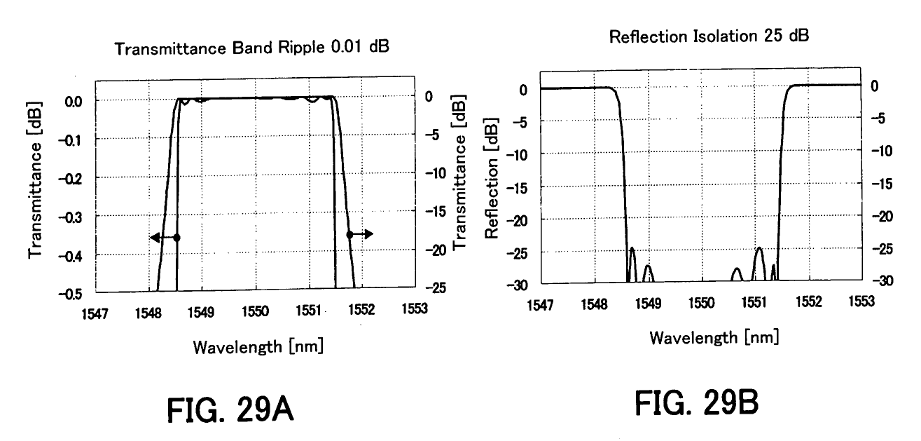

FIGS. 28(A),28(B),29(A) and 29(B) show examples of design of 4skip0-100 GHz filter.

The ripple is 0.13 dB occurring in the transmittance band when a 4skip0-100 GHz filter is designed using the conventional method for reducing the ripple by adjusting the number of layers of mirror layer and the film thickness of the spacer layer. The reflection isolation characteristic in the same band is about 15 dB.

The ripple occurring in the transmittance band is 0.01 dB when each cavity characteristics are adjusted (optimized) by forming the spacer layer of each cavity constituting a multi-cavity structure in a multi-layer structure as in the present invention. The reflection isolation characteristic in the same band is about 25 dB.

The ripple is improved from 0.13 dB to 0.01 dB, and the reflection isolation is improved from 15 dB to 25 dB, thus resulting in significant improvements.

Further, according to the present invention, it is possible to reduce the ripple in oblique incidence.

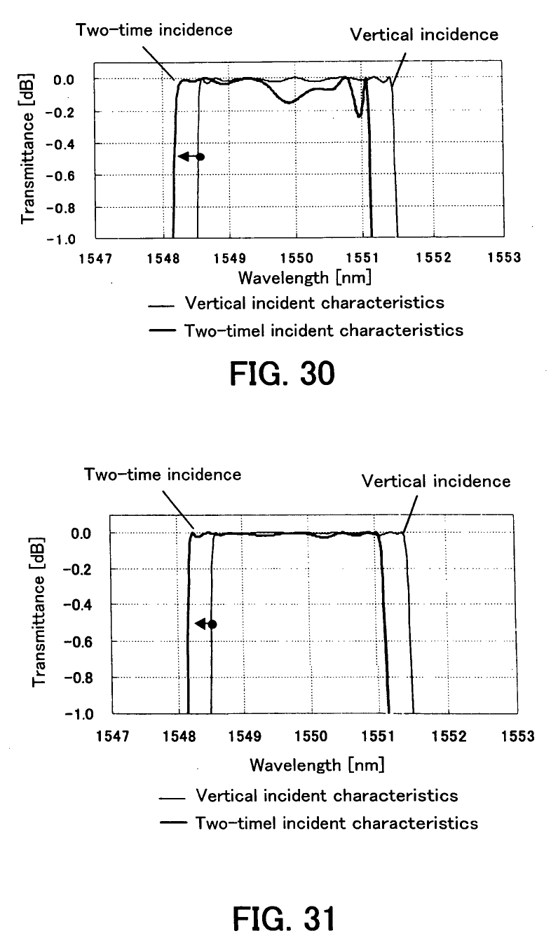

FIGS. 30 and 31 illustrate the comparison between the design in consideration of characteristics in oblique incidence and the design without such consideration.

FIG. 30 illustrates the design where the spacer layer is formed of a multi-layer structure, whereby the ripple is reduced in the transmittance band in vertical incidence.

FIG. 31 illustrates the design where the spacer layer is formed of a multi-layer structure, whereby the ripple is reduced in the transmittance band in vertical incidence, and further each cavity is adjusted so as to exhibit a wavelength shift of similar extent in oblique incidence.

FIGS. 30 and 31 show waveforms of vertical incidence and two-time incidence.

In the characteristics in vertical incidence, both design exhibits the ripple of 0.02 dB or less in the transmittance band. Meanwhile, the ripple in two-time incidence is 0.2 dB or 0.02 dB or less, thus resulting in a large difference.

When adopting the design such that each cavity is adjusted so as to exhibit a wavelength shift of similar extent in oblique incidence as in the present invention, it is possible to reduce the ripple in oblique incidence.

Further, it is possible to provide a plurality of transmittance bands.

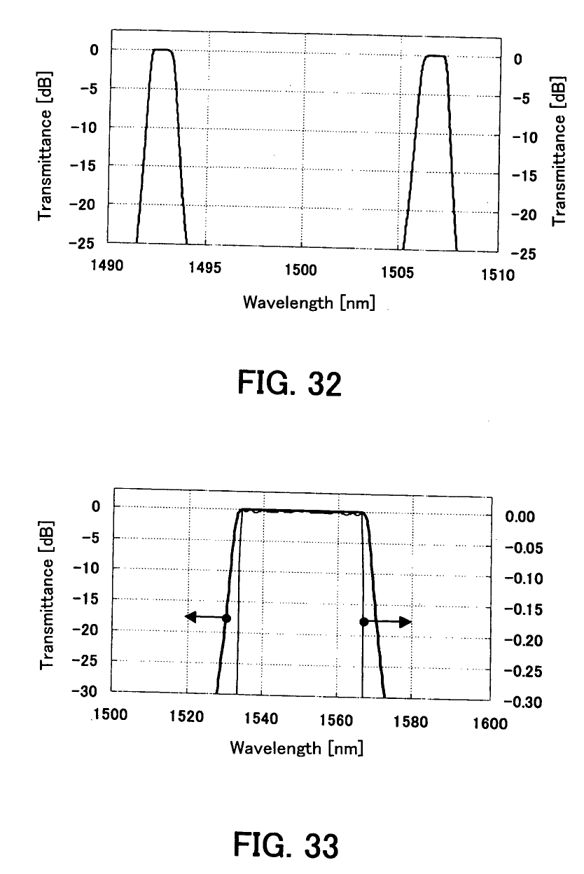

FIG. 32 shows waveforms of a band-pass filter of design such that the spacer layer has amulti-cavity structure comprisedof two cavities. By forming a spacer layer in multi-cavity structure, it is possible to provide two transmittance bands of which the number is 1 conventionally.

An optical add-drop system using the dielectric multi layer thin film optical filter as described above will be described below.

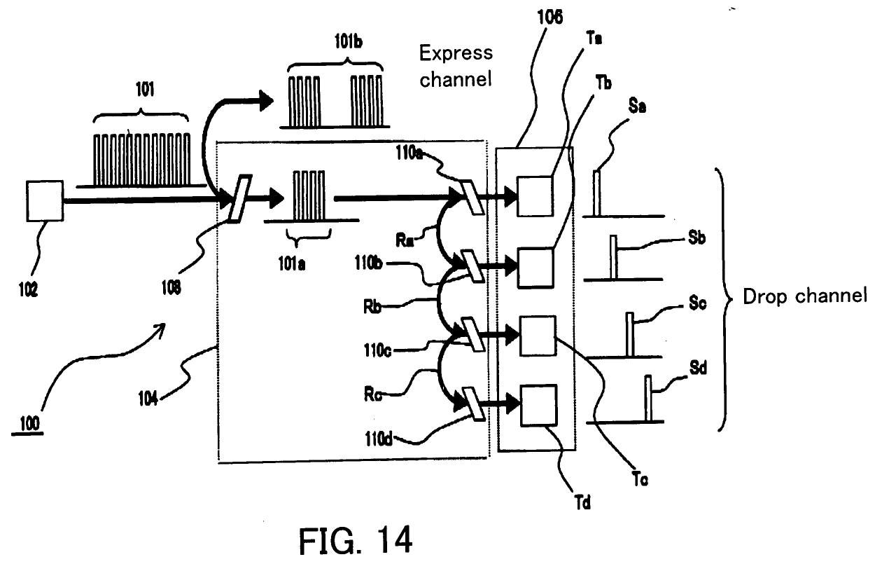

FIG. 14 is a configuration diagram of an optical add-drop system 100.

The system has a transmission end 102 that outputs signal light 101, a filter portion 104 where dielectric multi layer thin film optical filters are arranged in stages, and a reception end 106 that receives signal light of an arbitrary channel transmitted or reflected in the filter portion 104. In this embodiment, as an example of a structure of the filter portion 104, a 4skip0 filter 108 is disposed in a first stage, and four 100 GHz-BFPs (band-pass filters), 110a, 110b, 110c and 110d are disposed in a second stage.

The signal light of a plurality of channels (12channels in FIG. 14) output from the transmission end 102 is incident on the 4skip0 filter 108 that is the first-stage dielectric multi layer thin film optical filter. Signal light of four channels existing in arbitrary bands transmitted through the 4skip0 filter 108 is passed through as a drop channel 101a, while signal light of remaining channels is reflected as an express channel 101b.

The signal light of four channels passed through the 4skip0 filter 108 is incident on a first filter in the second stage, 100 GHz-BPF 110a. Only signal light of an arbitrary channel, Sa, is passed through the first filter, 100 GHz-BPF 110a, and dropped in a reception end Ta. Signal light of three channels, Sb, Sc and Sd, except Sa is reflected as reflected light Ra, and is incident on a second filter, 100 GHz-BPF 110b.

Only signal light of an arbitrary channel, Sb, is passed through the second filter, 100 GHz-BPF 110b, and dropped in a reception end Tb. Signal light of two channels, Sc and Sd, except Sb is reflected as reflected light Rb, and is incident on a third filter, 100 GHz-BPF 110c.

Only signal light of an arbitrary channel, Sc, is passed through the third filter, 100 GHz-BPF 110c, and dropped in a reception end Tc. Signal light of a single channel, Sd, except Sc is reflected as reflected light Rb, and is incident on a fourth filter, 100 GHz-BPF 110d.

Only signal light of an arbitrary channel, Sd, is passed through the fourth filter, 100 GHz-BPF 110d, and dropped in a reception end Tb.

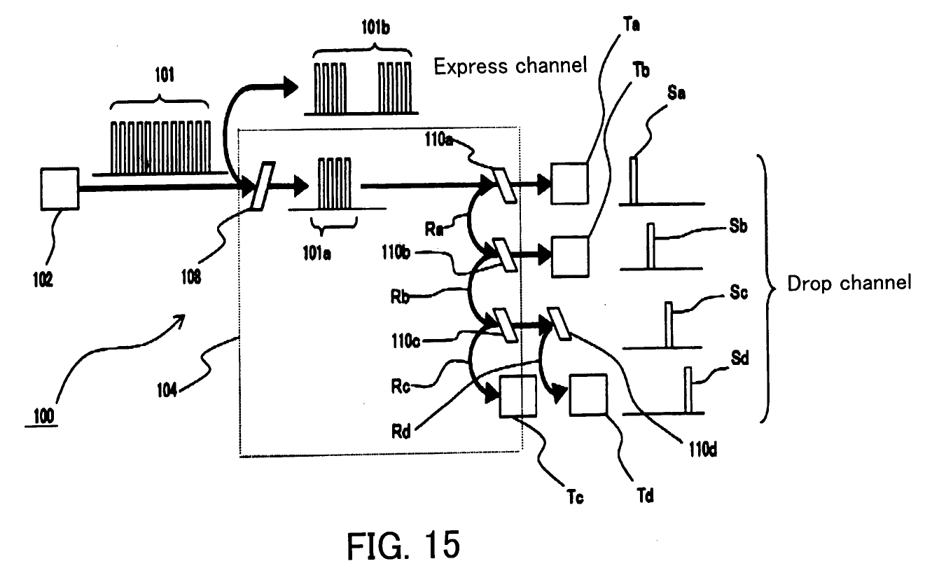

As described above, the signal light 101 incident on 12 channels is dropped in reception ends Ta to Tb as signal light of one channel, Sa, Sb, Sc or Sd, respectively. In addition, the filter portion 104 in FIG. 14 is illustrative of a single example of structure, and may be configured as shown in FIG. 15, where channel Sd is reflected in the fourth filter, 100 GHz-BPF 110c. In this case, the signal light of channel Sd passed through the third filter, 100 GHz-BPF 110c is reflected in the fourth filter, 100 GHz-BPF 110d, and dropped in the reception end Td.

In addition, various structures of the filter portion 104 (not shown) are considered in addition to FIGS. 14 and 15. For example, the filter portion may have a structure where a 4skip0 filter is disposed in the first stage, a 2skip0 filter is disposed as a first filter in the second stage, and two 100 GHz-BPFs are disposed in the third stage.

Further, the filter portion does not need to have a 4skip0 filter arranged always in the first stage, and an optical add-drop system can be constructed by disposing a z skip0 (z is an integer) filter and combining arrangements of filters in the second and subsequent stages. In other words, by changing a combination and arrangement of the z skip0 filter and 100 GHz-BPFs corresponding to the umber of channels dropped in reception ends, it is possible to construct a desired optical add-drop system. In addition, in this embodiment 100 GHz-BPFs are used since channel intervals is 100 GHz, it may be possible to use 50 GHz-BPFs, 200 GHz-BPFs, 400 GHz-BPFs or the like corresponding to the channel interval.

The effect of compensating (canceling) for GDR (Group Delay Ripple) will be described below obtained by combining transmittance and reflection effectively of five dielectric multi layer thin film optical filters, 108, 110a, 110b, 110c and 110d, constituting the optical add-drop system.

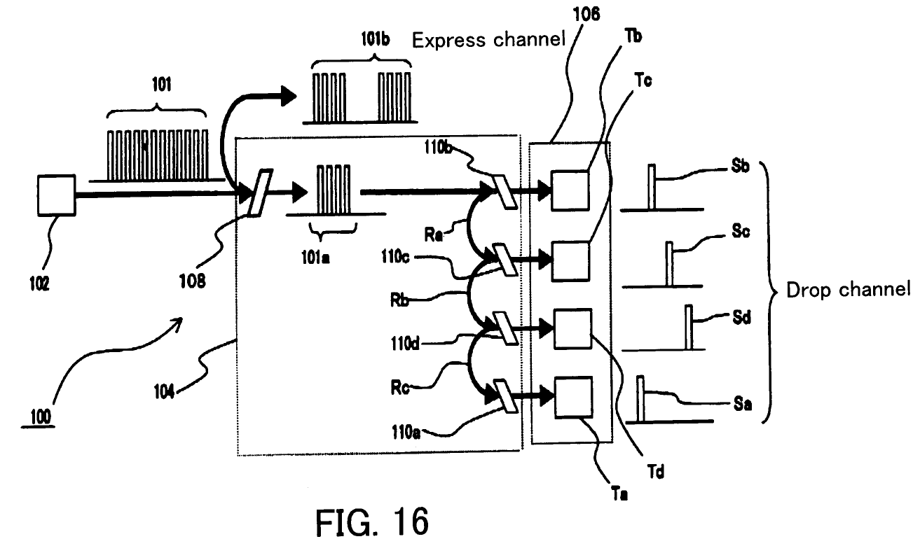

FIG. 16 shows a configuration of an optical add-drop system where signal light is dropped on channels Sb, Sc, Sd and Sa in this order.

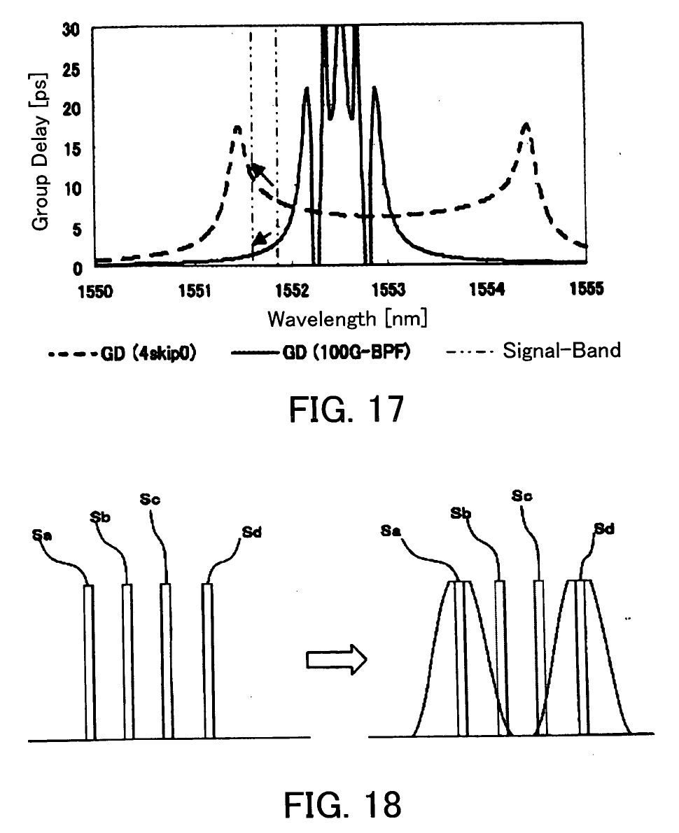

GDR on reflected light Rb is considered in FIG. 16. FIG. 17 shows GDR in reflection of the 4skip0 filter 108 and 100 GHz-BPF 110b that drops the signal light of channel Sb. As can be seen from FIG. 17, GDR is canceled by passing the light through the 4skip0 filter 108 and then reflecting the signal light of channel Sa by the 100 GHz-BPF 110b.

More specifically, GDR in the signal light band of the channel Sa in the 4skip0 filter 108 tends to increase toward shorter wavelengths, while GDR in the signal light band of the channel Sa in the 110 GHz-BPF 110b that drops the signal light of channel Sb tends to decrease toward shorter wavelengths.

In other words, GDR generated in the signal light band of the channel Sa caused by passing through the 4skip0 filter 108 is canceled by reflecting by the 100 GHz-BPF 110b, and thus decreases.

In FIG. 17, GDR in the signal light band of channel Sa is 3.034 ps after passing through the 4skip0 filter 108. Then, GDR is 1.607 ps in the signal light band of channel Sa in the reflected light Rb reflected by the 100 GHz-BPF 110b. It is thus understood that GDR is canceled and decreases.

Table 15 as described below shows GDR and CD (Chromatic dispersion) characteristics of each channel when the signal light is dropped on channels Sb, Sc, Sd and Sa in this order. In addition, as a comparative example, Table 16 shows GDR and CD (Chromatic dispersion) characteristics of each channel when the signal light is dropped on channels Sa, Sb, Sc and Sd in this order.

It is understood from comparison between the tables that GDR and CD (max) of channel Sa are both smaller in FIG. 15 than in FIG. 16.

TABLE 15

| Drop Channel | T(a) | T(b) | T(c) | T(d) |
|---|---|---|---|---|
| BW@-0.30 dB | 0.541 | 0.637 | 0.631 | 0.543 |
| [nm] | | | | |
| BW@-25.00 dB | 0.918 | 1.163 | 1.060 | 0.921 |
| [nm] | | | | |
| GDR [ps] | 2.081 | 0.806 | 1.679 | 2.100 |
| CD(Min) | −17.811 | −11.399 | −10.111 | −34.878 |
| [ps/nm] | | | | |
| CD(Max) | 35.036 | 13.336 | 22.591 | 17.754 |
| [ps/nm] | | | | |

TABLE 16

| Drop Channel | T(a) | T(b) | T(c) | T(d) |
|---|---|---|---|---|
| BW@-0.30 dB | 0.549 | 0.631 | 0.631 | 0.544 |
| [nm] | | | | |
| BW@-25.00 dB | 1.023 | 1.059 | 1.060 | 0.921 |
| [nm] | | | | |
| GDR [ps] | 3.150 | 2.068 | 1.786 | 2.076 |
| CD(Min) | −5.692 | −8.144 | −9.689 | −34.748 |
| [ps/nm] | | | | |
| CD(Max) | 38.848 | 24.582 | 23.296 | 17.935 |
| [ps/nm] | | | | |

A structure will be described below for further decreasing GDR and CD on a channel to drop.

A case is described where signal light 101a transmitted through the 4skip0 filter 108 is dropped on channels Sb, Sc, Sd and Sa in this order. When signal light of channels Sb and Sc is dropped, as shown in FIG. 18, no signal light exists between channels Sd and Sa. Therefore, channels Sd and Sa are isolated to some extent. Accordingly, as 100 GHz-BPFs 110d and 110a to drop the signal light of channels Sd and Sa, a 100 GHz-BPF with moderated isolation as shown in FIG. 18 may be used.

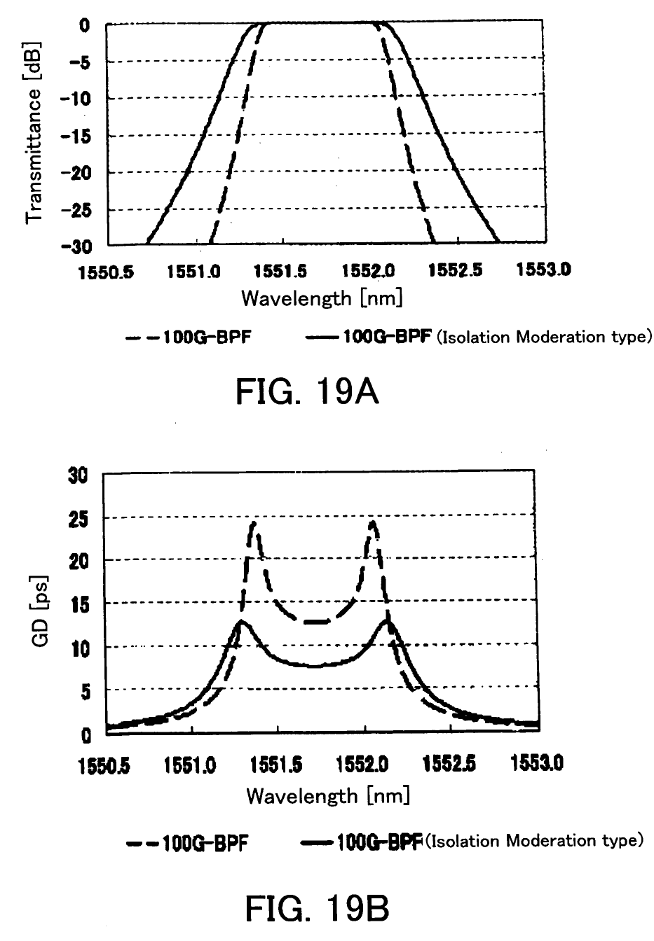

FIGS. 19(A) and 19(B) respectively show transmittance characterizes and GDR of a general 100 G-BPF and isolation moderation type 100 G-BPF. As shown in FIG. 19(B), the isolation moderation type 100 G-BPF has small CDR and CD, and therefore, is capable of suppressing GDR and CD occurring in the signal light of channels Sd and Sa. In other words, it is possible to construct an optical add-droop system with small GDR and CD.

Table 17 shows GDR and CD characteristic values of each channel when the signal light is dropped on channels Sb, Sc, Sd and Sa in this order and the isolation moderation type 100 GHz-BPF is used to drop the signal light of channels Sd and Sa.

TABLE 17

| Drop Channel | T(a) | T(b) | T(c) | T(d) |
|---|---|---|---|---|
| BW@-0.30 dB | 0.570 | 0.636 | 0.631 | 0.57 |
| [nm] | | | | |
| BW@-25.00 dB | 1.021 | 1.163 | 1.060 | 1.024 |
| [nm] | | | | |
| GDR [ps] | 1.703 | 0.808 | 1.679 | 1.725 |
| CD(Min) | −9.832 | −11.399 | −10.111 | −26.859 |
| [ps/nm] | | | | |
| CD(Max) | 26.976 | 13.336 | 22.591 | 9.671 |
| [ps/nm] | | | | |

As can be seen from Table 17, both GDR and CD have further smaller values in Table 17 than values in Table 15. CD is ±30 ps/nm or less on all the channels. In addition, as a 100 GHz-BPF to drop the signal light of channels Sa and Sd, a filter may be used such that GDR and CD characteristics of a 4skip 0 filter are shifted to shorter wavelengths.

An example will be described below of using an edge filter.

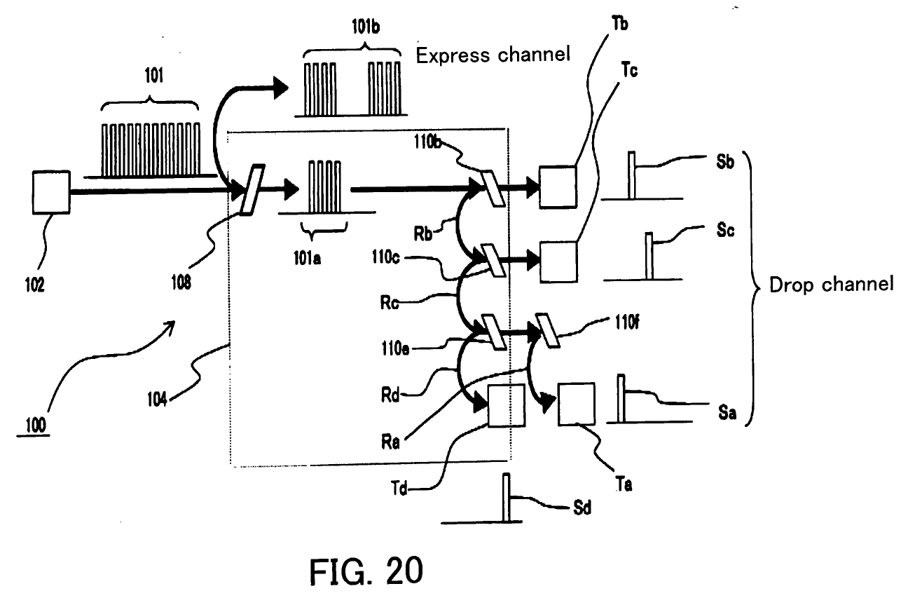

FIG. 20 illustrates an optical add-drop system where edge filters are used to reflect signal light in dropping the signal light of channels Sd and Sa. The other structure is the same as in FIG. 15.

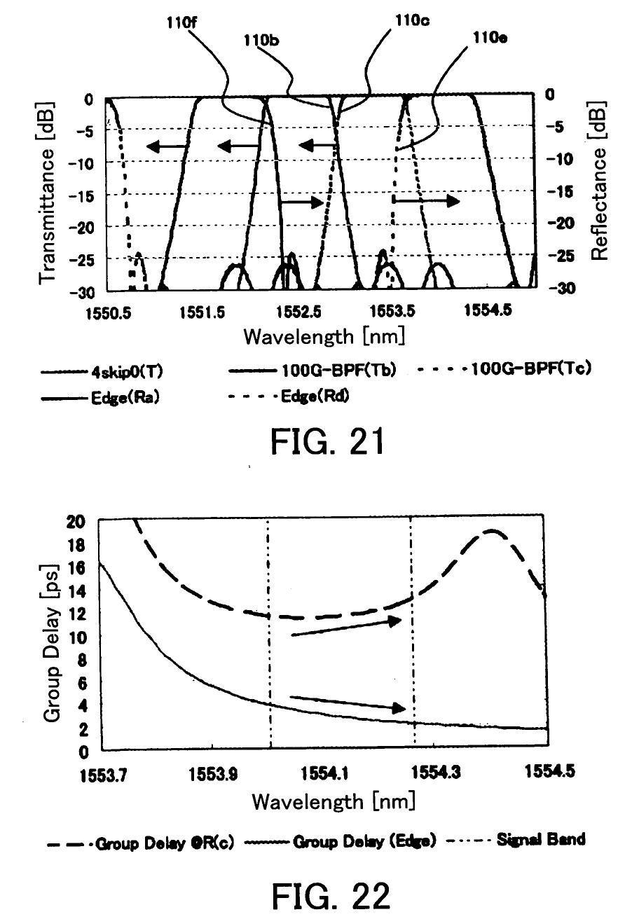

FIG. 21 shows characteristics of edge filters 110e and 110f and transmittance characteristics of 100 GHz-BPFs 110b and 110c to drop the signal light of channels Sb and Sc. The edge filter 110f to drop the signal light of the channel Sa is designed so as to reflect light in all bands of wavelengths shorter than the signal light band of the channel Sa, while transmitting light in bands longer than the band of the channel Sa. The edge filter 110e to drop the signal light of the channel Sd is designed so as to reflect light in all bands of wavelengths shorter than the signal light band of the channel Sd, while passing light in bands longer than the band of the channel Sd.

FIG. 22 shows accumulation GDR in reflected light Rc and GDR of the edge filter 110e to drop the channel Sd. The accumulation GDR in Rc is canceled (compensated) by GD of the edge filter 110e in the signal light band of the channel Sd. As a result, as shown in Table 18, GDR and CD both have small values, and CD have values less than ±25 ps/nm on all the channels.

TABLE 18

| Drop Channel | T(a) | T(b) | T(c) | T(d) |
|---|---|---|---|---|
| BW@-0.30 dB | 0.537 | 0.637 | 0.631 | 0.538 |
| [nm] | | | | |
| BW@-25.00 dB | 1.084 | 1.163 | 1.061 | 1.087 |
| [nm] | | | | |
| GDR [ps] | 1.003 | 0.806 | 1.679 | 1.165 |
| CD(Min) | −16.067 | −11.399 | −10.111 | −19.121 |
| [ps/nm] | | | | |
| CD(Max) | 20.928 | 13.336 | 22.591 | 17.003 |
| [ps/nm] | | | | |

An optical add-drop system will be described below where the 4skip0 filter in the first stage (as shown in FIG. 14) is not disposed and a plurality of 100 GHz-NBPFs (Narrow Band-pass Filters) are arranged.

Tables 19 to 22 show GDR and CD characteristics for each channel occurring when the order is changed in which the signal light of channels Sa, Sb, Sc and Sd is dropped. In addition, there are four orders in which channels are dropped. By comparing results, it is understood that a configuration (Table 21) where signal light is dropped on channels Sa, Sd, Sb and Sc in this order has the smallest values of GDR and maximum CD. In this way, in optical add-drop systems, by selecting filters having GDR and CD for mutually canceling GDR and CD in the signal light incident on each filter and determining the order in which the signal light is dropped, it is possible to limit GDR and CD occurring on each channel to small values.

TABLE 19

| Drop Channel | T(a) | T(b) | T(c) | T(d) |
|---|---|---|---|---|
| BW@-0.30 dB | 0.637 | 0.631 | 0.631 | 0.632 |
| [nm] | | | | |
| BW@-25.00 dB | 1.163 | 1.059 | 1.061 | 1.061 |
| [nm] | | | | |
| GDR [ps] | 0.646 | 1.850 | 1.964 | 1.997 |
| CD(Min) | −11.958 | −8.783 | −8.341 | −8.187 |
| [ps/nm] | | | | |
| CD(Max) | 12.050 | 23.210 | 23.942 | 24.166 |
| [ps/nm] | | | | |

TABLE 20

| Drop Channel | T(a) | T(b) | T(c) | T(d) |
|---|---|---|---|---|
| BW@-0.30 dB | 0.637 | 0.625 | 0.638 | 0.632 |
| [nm] | | | | |
| BW@-25.00 dB | 1.163 | 0.955 | 1.164 | 1.061 |
| [nm] | | | | |
| GDR [ps] | 0.646 | 1.117 | 0.731 | 1.997 |
| CD(Min) | −11.958 | −19.960 | −11.588 | −8.187 |
| [ps/nm] | | | | |
| CD(Max) | 12.050 | 19.962 | 12.764 | 24.166 |
| [ps/nm] | | | | |

TABLE 21

| Drop Channel | T(a) | T(b) | T(c) | T(d) |
|---|---|---|---|---|
| BW@-0.30 dB | 0.637 | 0.631 | 0.626 | 0.638 |
| [nm] | | | | |
| BW@-25.00 dB | 1.163 | 1.059 | 0.957 | 1.165 |
| [nm] | | | | |
| GDR [ps] | 0.646 | 1.756 | 1.197 | 0.669 |
| CD(Min) | −11.958 | −9.483 | −19.519 | −11.855 |
| [ps/nm] | | | | |
| CD(Max) | 12.050 | 22.788 | 20.704 | 12.259 |
| [ps/nm] | | | | |

TABLE 22

| Drop Channel | T(a) | T(b) | T(c) | T(d) |
|---|---|---|---|---|
| BW@-0.30 dB | 0.630 | 0.637 | 0.631 | 0.632 |
| [nm] | | | | |
| BW@-25.00 dB | 1.058 | 1.164 | 1.081 | 1.061 |
| [nm] | | | | |
| GDR [ps] | 1.995 | 0.649 | 1.852 | 1.966 |
| CD(Min) | −24.077 | −12.038 | −8.763 | −8.318 |
| [ps/nm] | | | | |
| CD(Max) | 8.237 | 11.964 | 23.237 | 23.984 |
| [ps/nm] | | | | |

In addition, with respect to the optical add-drop system, only “drop” is described in the foregoing. However, similar descriptions are obviously given to “add”.

As described above, according to the dielectric multi layer thin film optical filter, method of manufacturing such a filter, and program for designing such a filter according to the present invention, it is possible to represent wavelength optical characteristics of each cavity using the center wavelength and full width of half maximum as parameters, and design and provide a dielectric multi layer thin film optical filter having predetermined wavelength optical characteristics in a predetermined wavelength band by the optimization process.

Further, in the manufacturing method as descried above, by selecting a cavity having a full width of half maximum close to a value obtained by the optimization process from a list of full width of half maximums beforehand calculated by using predetermined refractive index values to determine, it is possible to reduce the design time dramatically as compared to the conventional method.

Furthermore, according to the dielectric multi layer thin film optical filter, method of manufacturing [symbol] such a filter, and program for designing such a filter according to the present invention, each laminated cavity is represented by a plurality of parameters including the number of layers of a mirror layer portion of the each cavity, film thickness of a spacer layer of the each cavity and optical film thickness of each refractive index layer constituting the mirror layer portion of the each cavity.

Then, each of the plurality of parameters is optimized to design a film structure of the each cavity, in such a manner that an error is decreased between optical characteristic values in the predetermined wavelength band of the entire cavities and target optical characteristic values corresponding to the predetermined wavelength optical characteristic values in the predetermined wavelength band, and that the ripple in the predetermined wavelength band is decreased.

Therefore, also in a dielectric multi layer thin film optical filter having a plurality of laminated cavities, i.e. so-called multi-cavity structure, it is possible to suppress the ripple and obtain optical characteristics adequately close to the target optical characteristics corresponding to the predetermined wavelength characteristics.

Further, since it is possible to adjust (optimize) characteristics of each cavity by forming in a multi-layer structure the spacer layer of each cavity constituting the multi-cavity structure, it is possible to decrease the ripple in the transmittance band. Furthermore, it is possible to provide two transmittance bands of which the number is one conventionally.

1. A dielectric multi layer filter comprising:
an optical substrate having a prescribed refractive index in a predetermined wavelength band of which center wavelength is λo;
a coupling layer having an optical film thickness of m1λo/4 (m1 being a positive odd number);
a cavity including a spacer layer having an optical film thickness of m2λo/4 (m2 being a natural number), and a mirror layer having an optical film thickness of m3λo/4 (m3 being a positive odd number) comprising two thin layers of two kinds of different refractive indexes in which said mirror layers are symmetrically arranged to said spacer layer in such manner that said two thin layers are alternately arranged; and
an anti-reflection layer having a prescribed optical film thickness,
wherein, a plurality of said cavities are layered through said coupling layers between said optical substrate and said anti-reflection layer, and each of said cavities is represented by a center wavelength and a full width of half maximum (FWHM), and is designed by an optimization process.

2. The dielectric multi layer filter as claimed in claim 1, wherein said center wavelength and said full width of half maximum of each of said cavities are obtained by causing a transmittance and wavelength property of each of said cavities to be approximate to Lorentz function.

3. The dielectric multi layer filter as claimed in claim 1, wherein each of said cavities is defined by selecting a cavity near to the full width of half maximum obtained by said optimization process from full width of half maximums calculated in advance by using prescribed refractive indexes.

4. The dielectric multi layer filter as claimed in claim 1, wherein said predetermined wavelength optical property includes that a ripple of the transmittance in the predetermined wavelength band of which a center wavelength is λo becomes small.

5. The dielectric multi layer filter as claimed in claim 4, wherein said ripple of the transmittance is up to 0.3 dB.

6. The dielectric multi layer filter as claimed in claim 1, wherein said two kinds of thin layers forming said mirror layer has an optical film thickness of λo/4 or 3λo/4.

7. The dielectric multi layer filter as claimed in claim 1, wherein the full width of half maximum of each of said cavities is different in the full width of half maximum of the cavities except the cavity in symmetric to a center of said layered cavities.

8. The dielectric multi layer filter as claimed in claim 6, wherein each of said cavities includes said thin layer having the optical film thickness of λo/4 and said thin layer having the optical film thickness of 3λo/4.

9. The dielectric multi layer filter as claimed in claim 8, wherein a position of said thin layer having the optical film thickness of 3λo/4 in each of said cavities is different in the cavities except the cavity in symmetric to a center of said layered cavities.

10. A manufacturing method of a dielectric multi layer filter comprising:
an optical substrate having a prescribed refractive index in a predetermined wavelength band of which a center wavelength is λo;
a coupling layer having an optical film thickness of m1λo/4 (m1 being a positive odd number);
a cavity including a spacer layer having an optical film thickness of m2λo/4 (m2 being a natural number), and a mirror layer having an optical film thickness of m3λo/4 (m3 being a positive odd number) comprising two thin layers of two kinds of different refractive indexes in which said mirror layers are symmetrically arranged to said spacer layer in such manner that said two thin layers are alternately arranged; and
an anti-reflection layer having a prescribed optical film thickness, wherein, a plurality of said cavities are layered through said coupling layers between said optical substrate and said anti-reflection layer,
which comprises the steps of:
representing each of said cavities by a center wavelength and a full width of half maximum; and
designing by an optimization process a multi layer thin film optical filter having a prescribed wavelength optical property.

11. The method as claimed in claim 10, wherein said center wavelength and said full width of half maximum of each of said cavities are obtained by causing a transmittance and wavelength property of each of said cavities to be approximate to Lorentz function.

12. The method as claimed in claim 10, wherein each of said cavities is defined by selecting a cavity near to the full width of half maximum obtained by said optimization process from full width of half maximums calculated in advance by using prescribed refractive indexes.

13. The method as claimed in claim 10, wherein a construction of said cavity having a prescribed full width of half maximum is calculated by introducing 3 λ o/4 as the optical film thickness of said thin layer.

14. A program readable by computer to design a multi layered thin films-optical filter comprising an optical substrate having a prescribed refractive index in a predetermined wavelength band of which a center wavelength is λo, a coupling layer having an optical film thickness of m1λo/4 (m1 being a positive odd number), a cavity including a spacer layer having an optical film thickness of m2λo/4 (m2 being a natural number), and a mirror layer having an optical film thickness of m3λo/4 (m3 being a positive odd number) comprising two thin layers of two kinds of different refractive indexes in which said mirror layers are symmetrically arranged to said spacer layer in such manner that said two thin layers are alternately arranged; and an anti-reflection layer having aprescribed optical film thickness, wherein, a plurality of said cavities are layered through said coupling layers between said optical substrate and said anti-reflection layer,
the program causing the computer to function to design the multi layered thin films-optical filter having a prescribed wavelength optical property, which comprises:
a step 1 of reading out a target optical property in correspondence to a prescribed wavelength optical property which is stored in a memory accessible to the computer;
a step 2 of reading out an initial value of each elements of said multi layered thin films-optical filter which is stored in a memory accessible to the computer;
a step 3 of optimizing each of said elements by an optimizing process;
a step 4 of selecting a cavity nearest to the said optimized full width of half maximum from the calculated full width of half maximums by using refractive indexes which is pre-stored in and read out from a memory accessible to the computer;
a step 5 of calculating an optical property based on each of the optimized elements to calculate an error from the targeted optical property;
a step 6 repeating steps from the step 2 to the step 5 until said error comes up to a prescribed value.

15. An optical add-drop system comprising a transmission terminal outputting an optical signal, a filter portion comprising a plurality of layered multi layer thin film optical filers as claimed in claim 1, and a reception terminal receiving an optical signal of a predetermined channels of partially transmitted through or reflected from the filter portion,
wherein said plurality of multi layered thin films-optical filters are arranged in such order that a dispersion property or a group delay property of the optical signal incident on each filters is canceled by the dispersion property or the group delay property of each of the multi layer thin film optical filters.

16. An optical add-drop process comprising the steps of: outputting an optical signal from a transmission terminal; transmitting or reflecting optical signals of predetermined channels by a filter portion comprising a plurality of layered multi layer thin film optical filers as claimed in claim 1; and propagating to a reception terminal,
wherein the dispersion property or the group delay property of the optical signal incident on each filters is canceled by the dispersion property or the group delay property of each of the multi layer thin film optical filters to transmit or reflect the optical signal of the predetermined channels.

17. A dielectric multi layer filter enable to transmit and/or reflect a predetermined wavelength band, wherein a film portion of said dielectric multi layer filter comprises a plurality of mirror layers comprising a plurality of layers (H) having a high refractive index material and a plurality of layers (L) having a low refractive index, which are alternately layered, and each of which has an optical film thicknessof λ/4, λ being a center wavelength as a standard of the optical film thickness; and a spacer layer having a total optical film thickness ofλ/2 times integral number, and comprising at least one layer (nH) (n being natural number) having a high refractive index material and at least one layer (nL) (n being natural number) having a low refractive index, which are combined, and each of which has an optical film thickness of λ/4 times integral number to the center wavelength.

18. The dielectric multi layer filter as claimed in claim 17, wherein both outermost layers in the spacer comprising multiple layers has an optical film thickness of λ/2 times integral number.

19. The dielectric multi layer filter enable to transmit and/or reflect a predetermined wavelength band, wherein at least two cavities each having said film portion as claimed in claim 17 are connected through at least one layer having an optical film thickness of λ/4 times integral number.

20. A dielectric multi layer filter to transmit a plurality of wavelength bands and reflect a remaining wavelength bands to an incident light from an angle without 0 degree,
wherein N (N being natural number at least two) number of cavities are connected through at least one layer having an optical film thickness of λ/4 times integral number, each of said cavity comprises a plurality of mirror layers comprising a plurality of layers (xH) having a high refractive index material and a plurality of layers (xL) having a low refractive index, which are alternately layered, and each of which has an optical film thickness of λ/4 times odd number; and a spacer layer comprising a single layer or multiple layers having a total optical film thickness of λ/2 times integral number; and
a ratio R of d to W, i.e., R=100×(d/w) [%] being up to 2%, where amaximum incident angle Φ (0 degree<Φ90 degrees) likely occurs when said filter is used, and when an incident light changes from 0 degree to Φ degrees, a difference between a maximum value and a minimum value is d of wavelength shifted amounts S(1), S(2), - - - , S(N) in each of N number of cavities, 0.5 dB width being W in a transmission waveform of the multiple cavities when the incident angle is 0 degree.

21. A dielectric multi layer filter to transmit a plurality of wavelength bands and reflect a remaining wavelength bands,
wherein a film portion of said dielectric multi layer filter comprises a plurality of mirror layers comprising a plurality of layers (H) having a high refractive index material and a plurality of layers (L) having a low refractive index, which are alternately layered, and each of which has an optical film thickness of λ/4 times odd number, λ being a center wavelength as a standard of the optical film thickness; and a multiple layered spacer layer,
said multiple spacer layer comprising a plurality of second mirror layers comprising a plurality of layers (H) having a high refractive index material and a plurality of layers (L) having a low refractive index, which are alternately layered, and each of which has an optical film thickness of λ/4 times odd number, and at least one second spacer layers comprising a single layer or multiple layers and having a total optical film thickness of λ/2 times integral number.

22. The dielectric multi layer filter as claimed in claim 21, wherein said second spacer layer comprising a plurality of third mirror layers comprising a plurality of layers (H) having a high refractive index material and a plurality of layers (L) having a low refractive index, which are alternately layered, and each of which has an optical film thickness of λ/4 times odd number, and at least one third spacer layers comprising a single layer or multiple layers and having a total optical film thickness of λ/2 times integral number.

23. The dielectric multi layer filter as claimed in claim 21, wherein nth (n being natural number of at least 4) spacer following said third spacer comprising a plurality of nth mirror layers comprising a plurality of layers (H) having a high refractive index material and a plurality of layers (L) having a low refractive index, which are alternately layered, and each of which has an optical film thickness of λ/4 times odd number, and at least one nth spacer layers comprising a single layer or multiple layers and having a total optical film thickness of λ/2 times integral number.

24. The dielectric multi layer filter enable to transmit and/or reflect a prescribed plurality of wavelength bands, wherein at least two cavities each having said film portion as claimed in claim 21 are connected through at least one coupling layer having an optical film thickness of λ/4 times odd number.

25. The optical add-drop system as claimed in claim 15, wherein said dispersion property or group delay property of the optical signal of each channels becomes smaller.
